(19) United States
(12) Patent Application Publication
(10) Pub. No.: US 2018/0263260 A1
(43) Pub. Date: Sep. 20, 2018

(54) EDIBLE PET PRODUCTS AND METHODS OF MAKING THE SAME

(71) Applicant: Mars, Incorporated, Mclean, VA (US)

(72) Inventors: Ralf Bela Reiser, Buffalo, NY (US); Chad A. Cepeda, Nashville, TN (US); Matthew Elliott, Wakefield (GB); Bradley Quest, Raymore, MO (US); Alex Camire, Marana, AZ (US); Francis S. Shields, Nashville, TN (US)

(73) Assignee: Mars, Incorporated, McLean, VA (US)

(21) Appl. No.: 15/985,249

(22) Filed: May 21, 2018

Related U.S. Application Data
(63) Continuation-in-part of application No. 15/947,108, filed on Apr. 6, 2018.
Application No. 15/947,108 is a division of application No. 14/437,689, filed on Apr. 22, 2015, now abandoned.
Application No. 14/437,689 is a continuation-in-part of application No. 14/774,092, filed on Sep. 9, 2015, now abandoned.
Application No. 14/774,092 is a continuation of application No. PCT/US2014/026771, filed on Mar. 13, 2014.
(60) Provisional application No. 61/716,913, filed on Oct. 22, 2012.
(60) Provisional application No. 61/792,805, filed on Mar. 15, 2013.

(51) Int. Cl. A23K 40/25; A23K 20/147; A23K 50/42; A23K 40/20

(52) U.S. Cl. CPC A23K 40/25; A23K 40/20; A23K 50/42; A23K 20/147

(57) ABSTRACT

A pet product comprising one or more natural colorants, and including or processed using one or more supercritical fluids is provided. The use of supercritical fluid not only can render the pet product with a more porous structure, it also can enhance the color provided by the natural colorants so that lesser amounts of colorants can be used while still providing a desired hue, shade or brightness.

This application is a continuation-in-part of U.S. application Ser. No. 15/947,108, filed on Apr. 6, 2018, which is a divisional of U.S. application Ser. No. 14/437,689, filed on Apr. 22, 2015, which is a 35 U.S.C. 371 of International Application No. PCT/US2013/066255, filed on Oct. 22, 2013, which claims benefit of U.S. Provisional Patent Application No. 61/716,913 filed on Oct. 22, 2012. This application is also a continuation-in-part of U.S. application Ser. No. 14/774,092, filed on Sep. 9, 2015, which is a continuation of International Application No. PCT/US2014/026771, filed on Mar. 13, 2014, which claims benefit of U.S. Provisional Application Ser. No. 61/792,805, filed Mar. 15, 2013. The entirety of each of these applications is hereby incorporated herein by reference for any and all purposes.

### FIELD

The present invention generally relates to edible pet products, including food, treats, and chews, and methods of making the same. More particularly, the present invention relates to edible pet products comprising a natural colorant, and that are processed using a supercritical fluid. Pet products so produced may desirably have an aerated or foamed structure, and due to the use of supercritical fluid lesser amounts of the natural colorant may be used while still achieving a desired hue.

### BACKGROUND

As owners become more aware and interested in organic, less processed food sources for themselves, many extend this desire to their pets, and pet products prepared from “all natural” ingredients are sought after in the marketplace.

Providing such products can be problematic for manufacturers, however, as natural alternatives for many ingredients utilized in the manufacture of pet products may not exhibit the same stability over time as their synthetic alternatives. Products made with some, or all, natural components may thus exhibit changes in appearance, taste, and/or nutritional content over time.

The market would welcome pet products that include natural components that exhibit a nutritional content, appearance and/or taste commensurate with similar products including synthetic ingredients. Pet products comprising one or more natural ingredients while also exhibiting shelf stability similar to that of similar products including synthetic ingredients would also be of benefit.

### SUMMARY

Pet products, e.g., food, treats, supplements and chews, are provided that include a natural colorant. Surprisingly, the use of a super critical fluid enhances the effect of the colorant so that less colorant may be used, while yet achieving the same hue, intensity or brightness of color that would otherwise require the use of a larger amount of the colorant. The pet products are processed using one or more supercritical fluids, and as a result, may have a lower density than pet products produced from the same, or similar compositions, not using a super critical fluid. By virtue of including the natural colorant, the pet products enjoy the benefit of being marketable as “all-natural”, while by virtue of being produced using a super critical fluid, the pet products may be lower in caloric density than pet products of the same composition, but produced without the use of super critical fluid.

A pet product composition is provided and comprises one or more natural colorants, the composition being saturated with a supercritical fluid. The composition comprises a protein component, the protein component comprising an amount of dairy protein of less than 10% by weight of the total weight of the composition. The protein component may further comprise 30-50% by weight fibrous protein and 15-25% gelling protein. The composition may comprise up to 40% by weight plasticizer, and in some embodiments, the plasticizer may be glycerin. The pet product composition may comprise additional ingredients, such as flavor enhancers, fat, vitamins, minerals, preservatives, and any combination thereof, in amounts of from 0.05-27.55% by weight.

The one or more natural colorants may comprise a combination of anthocyanins and turmeric, and in such embodiments, the combined amount of the anthocyanins and turmeric comprises from about 0.005% to 5.0% by weight of the chew. The combination of anthocyanins and turmeric provides the pet product composition with a green color having a Pantone reference range of from about P 163-14 U to about P 165-16 U. Or, the combination of anthocyanins and turmeric provides the pet product composition with a green color having a wavelength of from 490 nm to 560 nm.

The amount of supercritical fluid used to produce, or within the pet product composition can be the same regardless of the particular natural colorant(s) used, and can be, e.g., from 0.01 to 5 wt %, or from 0.01 to 3 wt %, or from 0.01 to 1 wt %, or from 0.01 to 0.5 wt %, or from 0.01 to 0.1 wt %, or from 0.01 to 0.05 wt %, based upon the total weight of the composition.

Change of the temperature and pressure of the composition is used to cause the supercritical fluid to expand and can result in the pet product composition, or a pet product formed from the composition, to have greater than 2×10⁴ cells per cubic centimeter (cc) of the aerated pet chew composition. The cells are created by the transformation of an amount of supercritical fluid to gas, sufficient to occupy 5-55% of the overall volume of the composition. The cells can have an average diameter of 0.05 to 200 μm.

Methods of making pet products are also provided and comprise preparing a pet product composition comprising one or more natural colorants and saturated with a super critical fluid. The temperature and pressure conditions surrounding the pet product composition are adjusted so that the supercritical fluid expands and diffuses at least partially through the pet product composition, which can cause the natural colorant to similarly diffuse. A pet product may be formed from the composition, e.g., by molding, such as injection molding, extrusion, or a combination of these.

In a further aspect, an aerated (or foamed as the terms are used interchangeably) pet chew composition comprising 5-90% by weight protein; 5-35% by weight of a water absorbing polymer, or combinations thereof; up to 40% of a plasticizer, such as glycerin, water, or combinations thereof; one or more natural colorants and an amount of supercritical fluid sufficient to occupy 5-55% of the overall volume of the composition when the supercritical fluid is transformed to gas. Kibbles, treats or supplements compositions may also be provided.

During or after processing, the gas transformed from the supercritical fluid preferably produces bubbles in the composition. Generally such bubbles have an average diameter between 0.05 to 200 μm. In preferred forms, the bubbles have a density greater than 2×10⁴ bubbles/cc. The bubbles may be uniformly or unevenly distributed within the pet product, and desirably, the distribution of the bubbles will be intentional.

Any natural colorant, or combination of colorants may be used, and in some embodiments, the natural colorants used provide the food, treat, supplement or chew with a green color, e.g., a combination of turmeric and one or more anthocyanins

Preferably, the surface roughness of the pet product is greater than that of a pet product not having a super critical fluid therein. The Ra (μm) value for the pet product of the present invention is preferably from about 4 to 15.

The average coefficient of friction for a pet product is preferably from about 0.136±0.001 to 0.235±0.049.

Preferably, the hardness of a pet product using the Vickers analysis ranges from about 0.003 to 0.02.

The tensile strength of the pet product of the present invention that includes a supercritical fluid preferably has about 15% to 50% of the tensile strength of a comparable pet product not processed using a supercritical fluid. Preferably, the ratio of peak distance to peak force is about 6:1 to 8:1 when comparing a pet product that includes a supercritical fluid to one that does not include a supercritical fluid.

The present invention also provides novel methods for making compositions in accordance with the invention. Such compositions are preferably injection molded or extruded to produce a final pet product from the composition. In some preferred forms when injection molding is used, the supercritical fluid contacts the composition during the injection molding process. In some preferred injection molding processes, the composition is extruded prior to the injection molding process. In some forms, the supercritical fluid is added to the composition during the extrusion process and prior to the injection molding process. When the composition is extruded to produce the final pet product, the supercritical fluid contacts the composition during the extrusion process.

### BRIEF DESCRIPTION OF THE DRAWINGS

FIG. 1 is a diagram of one embodiment of a method of producing a pet product;

FIG. 2 is a diagram of one embodiment of a method of producing a pet product;

FIG. 3 is a diagram of one embodiment of a method of producing a pet product;

FIG. 4 is a schematic drawing of one embodiment of a method of producing a pet product;

FIG. 5 is an illustration of one embodiment of a pet chew;

FIG. 6 is a graph showing cell size distribution for a 1 cubic centimeter sample size of one embodiment of a pet product and a control pet product;

FIG. 7 is a graph showing tensile strength of one embodiment of a pet product and a control pet product;

FIG. 8 is a graph showing the Young's modulus, ultimate strength, ductility and modulus of toughness for one embodiment of a pet product and a control pet product;

FIG. 9 is a diagram of one embodiment of a method of producing a pet product;

FIG. 10 is a diagram of one embodiment of a method of producing a pet product;

FIG. 11 is a diagram of one embodiment of a method of producing a pet product;

FIG. 12 is a schematic drawing of one embodiment of a method of producing a pet product; and

FIG. 13 is a diagram of one embodiment of a method of producing a pet product.

### DETAILED DESCRIPTION

The embodiments of the invention described herein are illustrative of the present invention and are not meant to be limiting.

A pet product and methods of making the pet product are provided. The pet product includes one or more natural colorants, and is processed using one or more supercritical fluids.

Pet chews are designed to remove plaque and tartar through mechanical abrasion while providing safe occupation and enjoyment. While the present pet chews provide rapid breakdown of the product once ingested by the animal, the present chews also provide significant reduction in plaque and tartar as compared to conventional pet products. The composition of the pet chew creates a nutritious and functional treat, which promotes a healthy lifestyle for the animal. A particularly preferred pet chew is designed for dogs, and most preferably a class of dogs, such as described in U.S. Provisional Application No. 60/815,686, filed Jun. 21, 2006, the entire disclosure of which is incorporated by reference herein.

The pet chew composition may be thermoplastic, and desirably comprises a protein, a water absorbing polymer, a plasticizer, one or more natural colorants and water. The pet chew of the invention is preferably a mono-component/mono-texture product. As used herein, mono-component/mono-texture product means that the chew product is a substantially homogeneous molded mass that be formed into any shape desired for a pet chew or treat.

The pet chew exhibits ductile properties so that when chewed, the animal's teeth sink into the product causing the product to break down in a controlled manner under repetitive stress. The edible thermoplastic material can be molded into a variety of shapes to provide good strength and stiffness and other desired physical properties to enhance functionality and chewing enjoyment.

The softer, chewier texture of the present pet chew improves animal enjoyment and demonstrates enhanced oral care efficacy. The pet chew composition of the invention provides a balanced blend of highly digestible proteins in a matrix of water-soluble materials to improve nutritional performance and animal safety.

Protein may be comprised of any protein such as, fibrous protein. The fibrous protein for the pet chew may be derived from animals, but can be formulated such that it does not include muscle protein, or plants. One skilled in the art would recognize that insubstantial amounts of muscle protein could be present. Fibrous proteins are generally strong and relatively insoluble. Due to such properties, fibrous proteins are important in providing the structural backbone of the pet chew product. Exemplary fibrous proteins include, but are not limited to, wheat protein, wheat gluten, corn zein, corn gluten, soy protein, peanut protein, casein, keratin and mixtures thereof. Particularly preferred fibrous proteins include, without limitation, wheat protein isolate, soy protein isolate, sodium caseinate and mixtures thereof. A highly preferred fibrous protein is a mixture of wheat protein isolate, soy protein isolate and sodium caseinate.

In some embodiments, the pet product may include all animal-derived protein, such as, e.g., casein, sodium caseinate, keratin or a combination of these. In other embodiments, the pet product may include only vegetable derived fibrous proteins, e.g., wheat protein, wheat protein isolate, wheat gluten, corn zein, corn gluten, soy protein, soy protein isolate, peanut protein, or combinations of these.

The water absorbing polymer may be a gelling protein, a hydrocolloid, an edible hydrogel, or mixtures thereof. Gelling protein, sometimes known as globular protein, generally comprises globelike proteins that are relatively soluble in aqueous solutions where they form colloidal solutions or gels. Exemplary gelling proteins include, but are not limited to gelatin, albumin, plasma, pea protein, lactoglobulins, surimi (fish) proteins, whey protein and mixtures thereof. A highly preferred gelling protein is gelatin. When used, the gelatin will preferably have a bloom strength in a range of about 100 to about 400, or from about 100 to about 200.

A hydrocolloid may be used as the water absorbing polymer. A hydrocolloid is generally defined as a macromolecule (e.g., a carbohydrate polymer or a protein) that is water soluble and forms a gel when combined with water. Exemplary hydrocolloids include, but are not limited to pectins, alginates, agars, carrageenan, xanthan gum, and guar gum.

An edible hydrogel may be used as the water absorbing polymer. The edible hydrogel may be a naturally occurring or synthetic material which swells in water or some liquid, retaining a large amount of the liquid without dissolving. Exemplary hydrogels include, but are not limited to maltodextrins, cetyl alcohol, chitosan, lecithins, polypeptides, waxes, and edible polymers.

Plasticizers dissolve in the polymer, separating polymer chains and thus facilitating molecular movement. Plasticizers are commonly used to increase workability, flexibility and extensibility of polymers. Plasticizers also reduce water activity of food systems by binding water that is otherwise available for biological reactions such as microbial growth. Exemplary plasticizers generally used in food applications include, but not limited to water, polyalcohols (e.g. sorbitol, mannitol, maltitol, glycerol and polyethylene glycol), gum arabic, hydrogenated starch hydrolysate and protein hydrolysate. For example, the plasticizer may be glycerol, hydrogenated starch hydrosylate, or a combination of these.

The pet chew composition may comprise protein in an amount of about 5 to about 90%, or from about 20 to about 80%, or from about 25% to about 60%, or even from about 30 to about 50% by weight of the composition, water absorbing polymer in an amount of about 5 to about 35%, or from 10 to about 30%, or from about 15 to about 25% by weight of the composition, plasticizer in an amount of about up to 40%, or from about 5 to about 40%, or from about 10 to about 35%, or from about 15 to about 30% by weight of the composition, and water in an amount of from about 1 to about 20%, or from about 2 to about 18%, or from about 5 to about 15% by weight of the composition. The pet chew composition will desirably contain starch in an amount less than about 5%, or less than about 4% and even less than about 3% by weight of the composition.

The pet chew of the present invention preferably contains an amount of supercritical fluid to occupy 5-55% of the overall volume of the composition after the supercritical fluid is transformed to gas within the matrix of the chew. A variety of amounts of supercritical fluid is envisioned, depending on the desired density of the resulting chew of the present invention. Preferably, the overall volume of the pet chew of the present invention occupied by the supercritical fluid can be, but is not limited to, any of the following amounts: 5-50% of the overall volume, 10-50% of the overall volume, 15-40% of the overall volume, 20-35% of the overall volume, 5-10% of the overall volume, 10-15% of the overall volume, 15-20% of the overall volume, 20-25% of the overall volume, 25-30% of the overall volume, 30-35% of the overall volume, 35-40% of the overall volume, 40-45% of the overall volume, 45-50% of the overall volume, and 50-55% of the overall volume after the supercritical fluid is transformed to gas within the matrix of the chew.

A pet product composition may contain an amount of supercritical fluid that is 0.05-0.25%, by weight, whereas this amount may have an amount of supercritical fluid sufficient to occupy 5-55% of the overall volume of the composition when the supercritical fluid is transformed to gas. Various amounts of supercritical fluid are envisioned, including but not limited to from about 0.05% to 0.1% by weight; 0.05% to 0.15% by weight; 0.1 to about 0.15%, by weight and any amounts therebetween as well as within the larger range provided above. The amount of supercritical fluid in some applications may be sufficient to occupy a volume of about 25%; 0.10% by weight, whereas this amount may be sufficient to occupy a volume of about 15%; and about 0.05%, a volume of 5%, or any range therebetween as well as within the larger range provided above. The supercritical fluid may be any known supercritical fluid, including nitrogen, carbon dioxide, or a combination of these. Supercritical fluid as that phrase is used herein, does not include supercritical steam. In some embodiments, the supercritical fluid may consist of nitrogen, carbon dioxide, or a combination of these.

The pet product composition further includes one or more natural colorants. Any natural colorant or combination of colorants may be used in order to provide the pet product with any desired colored. In those instances, wherein the pet product is to be a pet chew, natural colorants sufficient to provide the pet product with a green color, e.g., a combination of turmeric and one or more anthocyanins may be used. In such embodiments, the other ingredients of the pet chew may also be natural such that the chew may be marketed as being “all-natural”. As used herein, “natural” or a “natural food product” refers to one that does not incorporate any synthetic chemicals, colorings or flavorings. For reference, the FDA does not object to the use of the term “natural” as long as the food does not contain added color, artificial flavors, or synthetic substances.

Anthocyanins are water-soluble vascular pigments that may appear red, purple, or blue depending on the pH. They are odorless and nearly flavorless. Anthocyanins may be found in the tissues of Vaccinium species, such as blueberry, cranberry, and bilberry; Rubus berries, including black raspberry, red raspberry, and blackberry; blackcurrant; cherry; eggplant peel; black rice; Concord grape; muscadine grape; red cabbage; violet petals; black soybean; skins of black chokeberry; Amazonian palm berry; blood orange; marion blackberry; cherry; redcurrant; purple corn; and acai. Although it is not necessary to provide anthocyanins in therapeutically effective amounts in order to achieve the benefits provided when used as a natural colorant, anthocyanins are known antioxidants, relax red blood vessels, and provide anti-inflammatory response in the body and are thought to protect against cancer, aging, neurological diseases, inflammation, diabetes, bacterial infections, fibrocystic disease, improve eyesight and combinations thereof. And so, in embodiments wherein therapeutic amounts of anthocyanins are included in the pet products, one or more of the aforementioned health benefits may also be provided.

Anthocyanins exhibit different colors at different levels of pH. In embodiments wherein the pet product, e.g., a chew, has a green color, the anthocyanins will desirably appear blue. The appropriate pH can be determined depending on the source of anthocyanins selected. For example, red cabbage appears blue at pH 8-9. when red cabbage provides the anthocyanins, the pH of the pet product composition may desirably range from pH 4.5-9. And so, in such embodiments, the pet chew composition may comprise a pH buffer and/or stabilizer to assist in the establishment and maintenance of a desired pH.

The pH buffer and/or stabilizer used can be any known in the art, and suitable for consumption. Weak acids, their base conjugates and combinations thereof are examples of useful pH buffers, and certain enzymes can also provide this function. Non-limiting examples of buffers include sodium citrate, calcium citrate, potassium citrate, monopotassium phosphate, and potassium tartrate. The turmeric and anthocyanins may be used along with a pH buffer to act as an indicator showing the oral care effectiveness of the pet chew. As the pet chews the treat, the pet chew may change color indicating that the requisite level of chewing to clean the pet's teeth has been achieved.

Turmeric or Curcuma longa is a rhizomatous herbaceous perennial plant of the ginger family, and the tissues from such plants may be used in fresh or powdered form to provide a yellow color to the pet product composition. Turmeric is a source of manganese, iron, vitamin B6, fiber, and potassium. Additionally, turmeric has anti-bacterial and anti-fungal properties along with anti-inflammatory activity and is thought be efficacious in the treatment or prevention of inflammatory bowel disease; rheumatoid arthritis; cystic fibrosis; various forms of cancer; including leukemia, melanoma, prostate cancer; depression; heart disease; and Alzheimer' s Disease and improves liver function. Although it is not necessary to provide turmeric in therapeutically effective amounts in order to achieve the benefits provided when used as a natural colorant, in embodiments wherein therapeutic amounts of turmeric is included in the pet products, one or more of the aforementioned health benefits may also be provided. The pH of the turmeric component is preferably from pH 4.5 to 6.5 for a yellow color and from pH 6.5 to 9 for an orangey hue.

The combined amount of anthocyanins and turmeric is desirably enough to produce a green colored pet chew similar to or identical to that of the present Greenies® treats (MARS, Inc.). That is, the green produced by the combination of anthocyanins and turmeric may desirably have a Pantone reference range from about P 163-14 U to P 165-16 U. Stated another way, the green color produced by the combination of anthocyanins and turmeric is preferably from about 560-490 nm wavelength or, alternatively, 540-610 THz frequency. The green color of the pet product, produced by one or more natural colorants, is desirably similar to or identical to the green color of the present Greenies® product (MARS, Inc.), or within ±20 nm of that green, or within ±10 nm of that green, or within ±5 nm wavelength of that green color. Alternative, the green color of the pet product is similar to or identical to the green color of the present Greenies® product (MARS, Inc.), or within ±20 THz of that green, or within ±10 THz of that green, or within ±5 THz frequency of that green.

The combined amount of the anthocyanins and turmeric is preferably from about 0.005% to 5.0% (by weight) of the formulation of the pet product, or from about 0.005% to 4%, or from about 0.005% to 3%, or from about 0.005% to 2%, or from about 0.005% to 1%, or from 0.005% to 0.045%, by weight, of the formulation.

The ratio of anthocyanins to turmeric within the pet product may be, e.g., from about 1:1, 1:1.5, 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:9.5, or 1:10, where the anthocyanins or turmeric can represent either side of the ratio. For example, embodiments are envisioned where the ratio of turmeric to anthocyanins is 1:2 as are embodiments wherein the ratio of turmeric to anthocyanins is 2:1. Preferably, the ratio of anthocyanins to turmeric in the pet product results in the pet product appearing green.

Conventionally, little color differentiation is possible in pet products, due to the similarity of the base materials. It has now been surprisingly discovered that use of supercritical fluid with small amounts of colorants can provide color differentiation among pet products. This is believed to be due to the fact that the microexpansion of the supercritical fluid within the pet product composition provides for the efficient and substantially uniform dispersion of the colorant within the composition. A desired hue and/or intensity may thus be achieved using lesser amounts of colorant that have been traditionally used to achieve the same hue or intensity in a pet product of the same composition and color. This effect is not seen with steam. Small amounts of supercritical fluid can have a large impact on color differentiation, i.e., amounts of from 0.01% to 0.05 percent by weight of the pet product composition have been observed to produce this effect.

The pet product composition may also contain at least one additional ingredient selected from the group consisting of fat, flavor enhancers, preservatives, and/or nutrients. As used herein, fat includes edible oils and preferably will be liquid fat at room temperature. Exemplary fats include corn oil, soybean oil, peanut oil, cottonseed oil, grapeseed oil, sunflower oil, flaxseed oil (and other sources of omega-3 and omega-6 fatty acids), vegetable oil, palm kernel oil, olive oil, tallow, lard, shortening, butter and combinations thereof. The fat may desirably be vegetable oil. If the fat is present, it will generally be in a range of about 1 to about 20%, preferably about 1.5 to about 10% and more preferably about 2 to about 5% by weight of the pet chew composition. Flavor enhancers are well known and the use of any and all such flavor enhancers is encompassed within the present invention. The pet product composition may also contain active ingredients for removal of plaque and tartar, and materials for breath freshening and general oral health. Other ingredients may also be included in the composition, for example, release agents, stabilizers, and emulsifiers.

One example of a pet product composition includes gelatin, wheat protein isolate, glycerin, pea protein, water, potato protein, sodium caseinate, natural poultry flavor, lecithin, minerals (dicalcium phosphate, potassium chloride, magnesium amino acid chelate, calcium carbonate, zinc sulfate, ferrous sulfate, copper sulfate, manganese sulfate, potassium iodide), vitamins (dl-alpha tocopherol acetate [source of vitamin E], L-ascorbyl-2-polyphosphate [source of vitamin C], vitamin B12 supplement, d-calcium pantothenate [vitamin B5], niacin supplement, vitamin A supplement, riboflavin supplement, vitamin D3 supplement, biotin, pyridoxine hydrochloride [vitamin B6], thiamine mononitrate [vitamin B1], folic acid), dried tomato, apple pomace, vegetable oil (preserved with mixed tocopherols), ground flaxseed, dried sweet potato, cranberry fiber, dried cultured skim milk, choline chloride, taurine, decaffeinated green tea extract, carotene, turmeric, and anthocyanins. This pet product composition may be used to provide a natural pet chew.

A further example of a pet product composition includes rice flour, glycerin, gelatin, wheat flour, water, oat fiber, lecithin, wheat protein isolate, apple pomace, tomato pomace, natural flavor, minerals (dicalcium phosphate, potassium chloride, magnesium amino acid chelate, calcium carbonate, zinc sulfate, ferrous sulfate, copper sulfate, manganese sulfate, potassium iodide), vitamins (dl-alpha tocopherol acetate [source of vitamin E], L-ascorbyl-2-polyphosphate [source of vitamin C], vitamin B12 supplement, d-calcium pantothenate [vitamin B5], niacin supplement, vitamin A supplement, riboflavin supplement, vitamin D3 supplement, biotin, pyridoxine hydrochloride [vitamin B6], thiamine mononitrate [vitamin B1], folic acid), sodium caseinate, ground flaxseed, dried cultured skim milk, choline chloride, taurine, decaffeinated green tea extract, carotene, turmeric, and anthocyanins. This pet product composition may be formed into a natural lite pet chew.

An additional exemplary pet product composition includes rice flour, glycerin, gelatin, wheat flour, water, oat fiber, lecithin, apple pomace, wheat protein isolate, dried chicken cartilage(source of glucosamine and chondroitin), tomato pomace, natural flavor, minerals (dicalcium phosphate, potassium chloride, magnesium amino acid chelate, calcium carbonate, zinc sulfate, ferrous sulfate, copper sulfate, manganese sulfate, potassium iodide), vitamins (dl-alpha tocopherol acetate [source of vitamin E], L-ascorbyl-2-polyphosphate [source of vitamin C], vitamin B12 supplement, d-calcium pantothenate [vitamin B5], niacin supplement, vitamin A supplement, riboflavin supplement, vitamin D3 supplement, biotin, pyridoxine hydrochloride [vitamin B6], thiamine mononitrate [vitamin B1], folic acid), vegetable oil (preserved with mixed tocopherols), sodium caseinate, ground flaxseed, dried cultured skim milk, choline chloride, taurine, decaffeinated green tea extract, carotene, turmeric, and anthocyanins. This pet product composition may be formed into a natural senior pet chew.

The pet chew exhibits ductile properties so that when chewed, the animal's teeth sink into the product causing the product to break down in a controlled manner under repetitive stress. The edible thermoplastic material can be molded into a variety of shapes to provide good strength and stiffness and other desired physical properties to enhance functionality and chewing enjoyment.

Unlike similar products in the marketplace, in preferred forms, the present pet chew product is designed to be 100% nutritionally complete and balanced for animal nutrition. The softer, chewier texture of the present pet chew improves animal enjoyment and demonstrates enhanced oral care efficacy. The pet chew composition of the invention provides a balanced blend of highly digestible proteins in a matrix of water-soluble materials to improve nutritional performance and animal safety.

The properties of the proteinaceous materials used in the pet chew are subject to chemical and physical interactions (e.g., protein/protein and with other materials including water absorbing polymers) to improve their solubility and textural properties to enhance oral care benefits and animal safety. Animal safety is achieved through product design to minimize risk in all areas. Control of texture minimizes risks of dental fractures; controlled product size reduction through chewing reduces risk of choking; and superior solubility/digestibility eliminates risk of intestinal blockage.

The pet chew of the present invention demonstrates high flexibility and elastic properties to improve chewing enjoyment and lasting time. The product is designed to break down in a controlled fashion under repetitive chewing. The texture of the pet chew ensures proper balance between animal safety, oral care efficacy, enjoyment and lasting time. Further, the breakdown or fracture of the pet chew of the invention under mechanical stress is controlled to avoid release of large pieces that can be swallowed intact and increase risk of choking and digestive obstruction.

In an embodiment of the invention, the surface roughness of the pet chew of the present invention is higher when compared to a pet chew that does not include a supercritical fluid therein. Surface roughness refers to the surface texture of the interior cross-section area, where this area makes surface contact with a tooth during the downward bite and upward pull involved with a chewing action. In an embodiment of the present invention, a pet chew of the present invention having a supercritical fluid demonstrates similar flexibility, hardness and elastic properties when compared to a pet chew that does not include a supercritical fluid therein. Preferably, the recipe or formulation of the pet chew of the present invention may be altered such that hardness, elasticity, and flexibility may be altered. In another embodiment, the pet chew of the present invention has softer textural properties when compared to a pet chew that does not include a supercritical fluid therein.

A method for naturally coloring a food product green is provided. The method generally comprises the steps of adding an amount of turmeric with an amount of anthocyanins to achieve a green color. The food product is preferably selected from a pet food product, a pet treat, a pet chew, and other food products. Desirably, the combination of the amount of turmeric and anthocyanins produce a green color from P 163-14 U to P 165-16 U on the Pantone Reference Range.

### Extrusion

The pet product composition is thermoplasticized, preferably by extrusion, and molded, e.g., injection molded, to form the pet chew product. One skilled in the art will readily recognize that the pet chew of this invention could also be prepared by compression molding, extrusion without molding or tableting techniques.

Extrusion, e.g., twin-screw extrusion, may be used to form the pet product composition into pellets. The pellets are subsequently melted and formed into particular shapes by post-extrusion forming, preferably by injection molding. Subsequent to injection molding, individual pieces of the products are trimmed for flash removal followed by cooling prior to packaging.

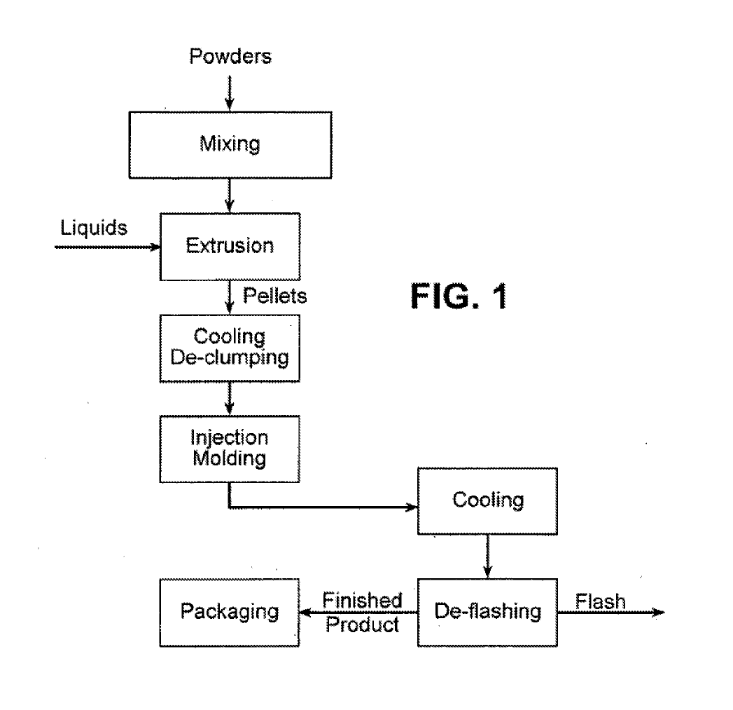

FIG. 1 shows a diagram of a method of producing a pet chew product according to the invention. As shown in FIG. 1, the manufacturing process from mixing of ingredients to finished product packaging can occur on a continuous basis. Powder ingredients are mixed in the mixer for about 5-30 minutes. Uniform mixture of powder ingredients is subsequently fed into an extruder, preferably a twin-screw extruder. Downstream from the powder inlet, liquid ingredients are added to transform the mixture of powder and liquid ingredients into a uniformly plasticized, moldable mass in the presence of heat and shear. During this process, the moldable mass is also cooked by the increased temperature in the extruder barrels. The temperature profile of the extruder barrels is determined by, among others, the composition, pressure, residence time in the extruder barrels, screw profile, screw speed and shear rate.

The temperature and shear in the extruder zones will be set to provide sufficient thermoplastification. This may be achieved with temperatures in a range of about 88° C. to about 141° C. in the middle zones and lower temperatures at either end of the barrel. Of course, greater temperatures may be employed in the middle zones.

Thus, the temperature can be controlled across the barrel to enable optional venting of energy and moisture along the extruder. Forced venting may also be achieved by using vent/vacuum stuffers at the end of process section where most cooking is achieved on the moldable mass inside the extruder barrel.

At the extruder exit, extrudate is forced through a die with small orifices. Immediately behind the die, the extrudate is exposed to increasing pressure and temperature due to the restriction imposed by the small die openings thus use of extra cooling becomes increasingly important to ensure pellet quality.

Subsequent to exiting the extruder die, the plasticized extrudate is cut at the die surface by a surface cutter equipped with at least one blade in to small pellets. Rotational speed of the cutter may be adjusted depending on the size requirements of the pellets in addition to flow properties of the extrudate. Product temperature at the die exit may range from about 82° C. to about 95° C., or about 85° C.

After cutting, pellets are placed on moving conveyors to carry the pellets away from the extruder exit. This process also facilitates cooling of the pellets to prevent caking which reduces the need for a subsequent de-clumping step in the process sequence. Conveyors may be kept at ambient temperatures, however, in order to reduce cooling time, forced air circulation with chiller air may be applied to induce rapid cooling.

Depending on the formulation, speed and extent of cooling, pellets may stick together forming clumps of variable sizes. These clumps must be reduced in size, achieved by de-clumping, to ensure a steady and stable injection molding process.

Subsequent to cooling and de-clumping, pellets are conveyed to injection molding, where the final product shape is achieved.

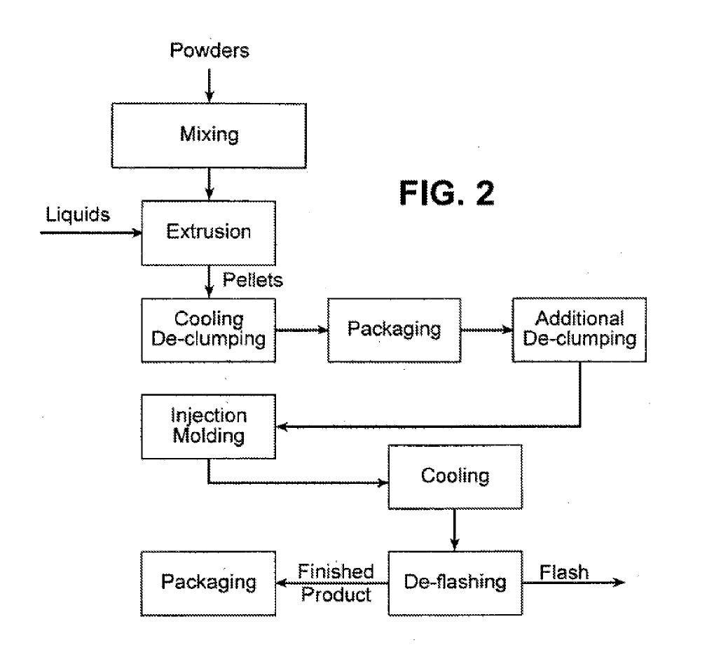

Another embodiment of a method of making the pet products can be seen in FIG. 2, in which pellets are manufactured well prior to being used in injection molding.

While the mixing, extrusion, cooling and de-clumping steps may be similar to that described in connection with FIG. 1, in the alternative manufacturing process illustrated in FIG. 2, pellets are packed into suitable containers upon cooling or de-clumping. For packaging, totes, sacks, super-sacks, barrels, cartons, etc. may be used for storage and transfer. The selection of packaging depends on, among others, packing characteristics of pellets, environmental and safety regulations, handling/transportation requirements, usage frequencies and sizes.

Pellet containers must be appropriate for target use and inert enough to protect their contents from external elements such as insects, birds, dust, temperature and humidity fluctuations, sun exposure, aroma and flavor transfer/leach from the containers.

Prior to injection molding, an additional de-clumping process may be required to break up clumps into individual pellets again if packing or clumping of pellets is observed in the containers during storage or transport. Upon de-clumping, pellets are molded into final product shape by injection molding as described below.

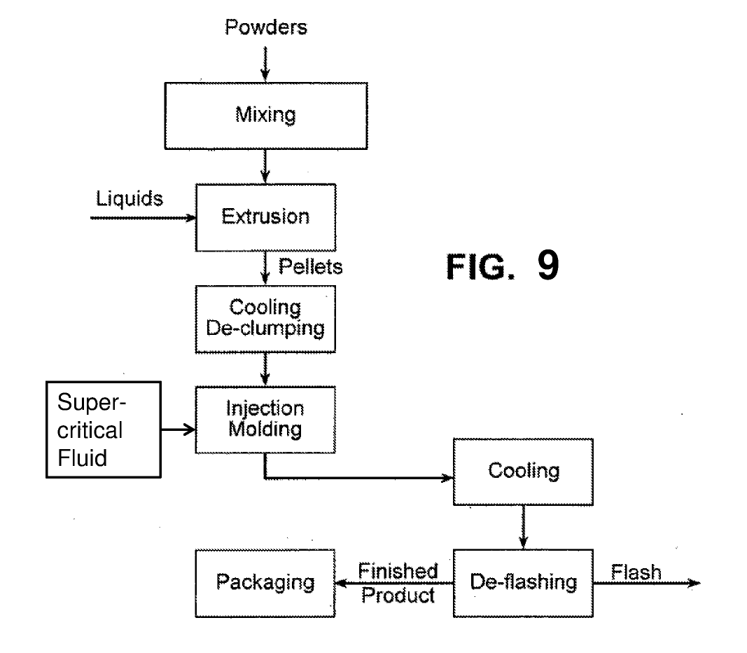

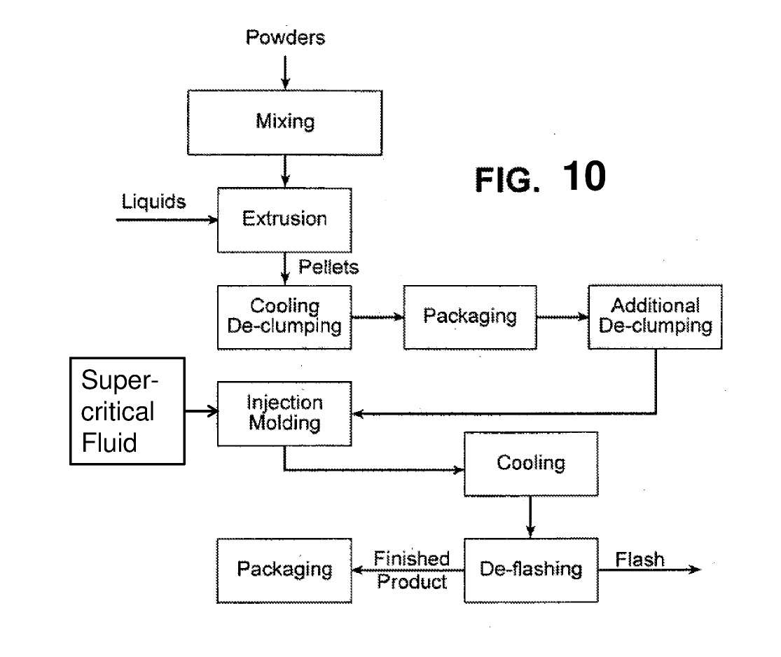

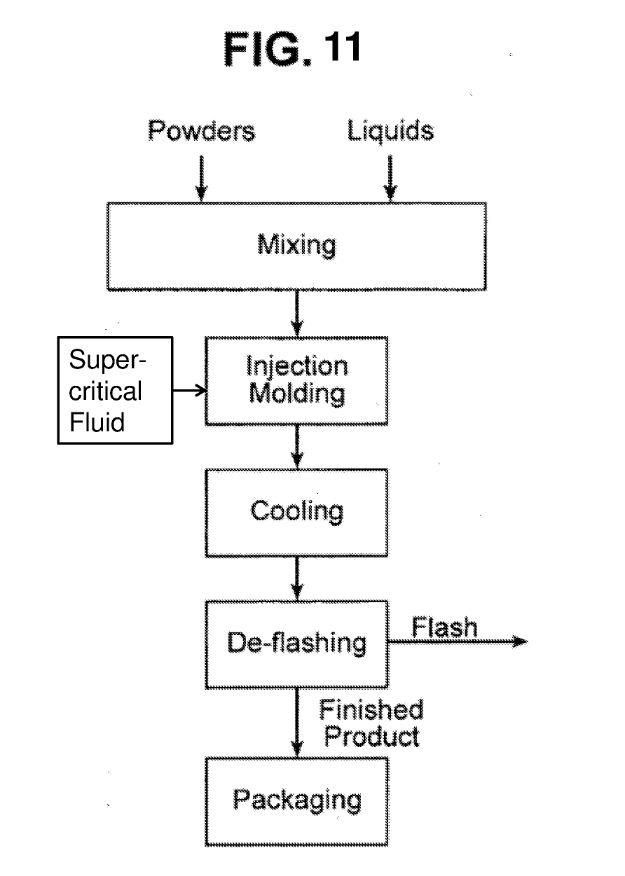

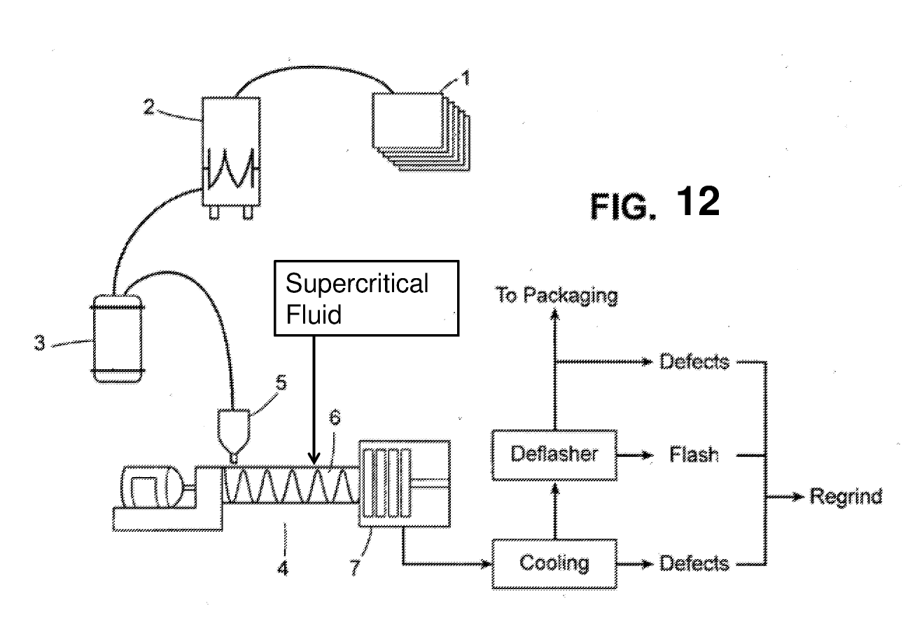

In the methods shown in FIGS. 9-12, a supercritical fluid is added to the extruded product either before or during the injection molding process. As can be appreciated, the use of a supercritical fluid and control of the temperature and pressure parameters will form the advantageous bubbles or foam in the final product.

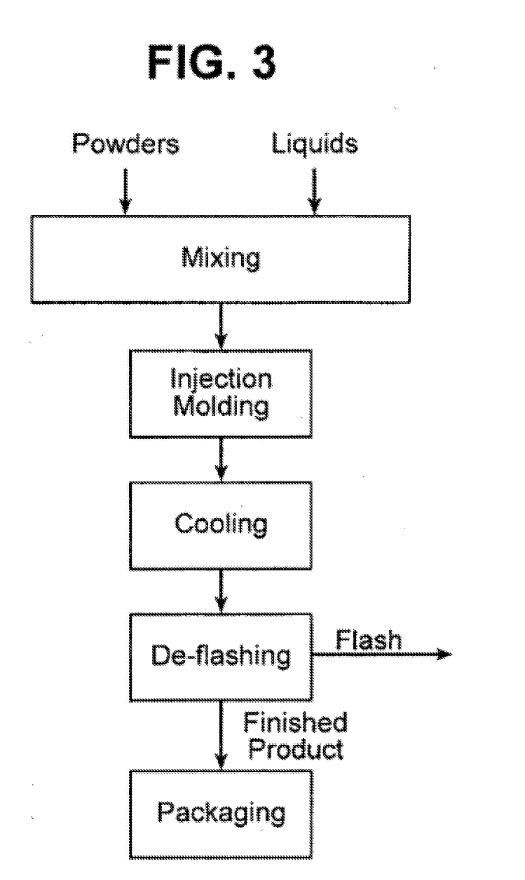

FIG. 3 shows yet another diagram of an exemplary method of producing the pet chew product according to the invention. The process, shown in FIG. 3, combines powder and liquid ingredients together in a high shear mixer to form a uniform mass. According to the process shown in FIG. 3, the pellet production step is also eliminated by feeding the uniform mass directly into the injection molder's barrel.

Subsequent to injection molding, the product is cooled and subjected to a de-flashing process where excess material on the product is removed. De-flashing may be achieved by vibration of product inside vibrating hoppers, vibrating tables and/or tumblers.

### Injection Molding

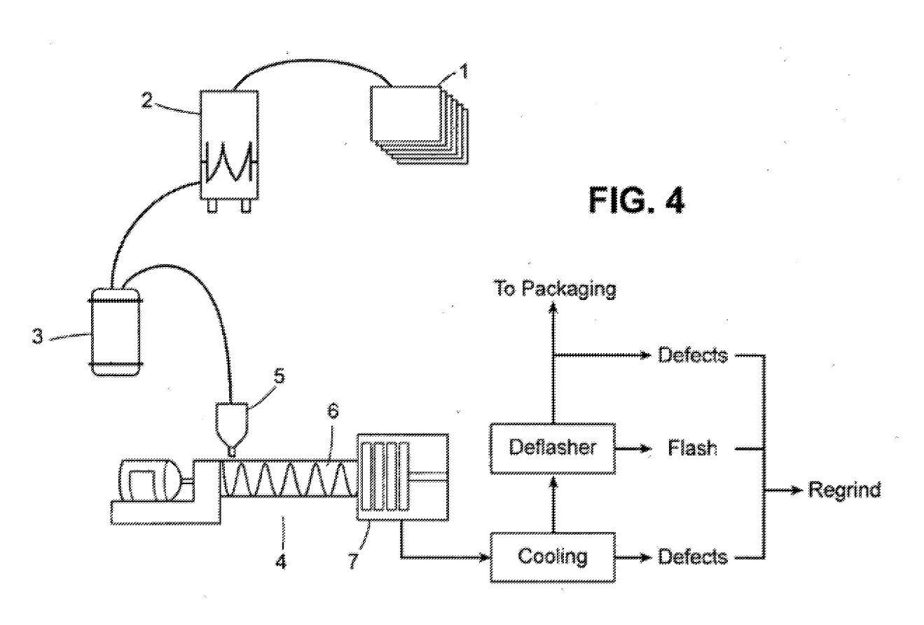

FIG. 4 shows a schematic drawing of the injection molding process that may be used to prepare the pet chew product according to the invention. Material for the injection molding process may be delivered in containers 1 in the form of pellets. Occasionally, due to transport, load pressure and the nature of the recipe, the pellets have a tendency to pack together and form large adhesive blocks. Thus, if necessary, each container is transferred to a de-clumper 2 to break up and separate the individual pellets to allow feeding into the injection molders 4. The individual pellets are collected in a container 3 and then vacuum fed to a feeder 5 leading to the injection molders for forming.

As the pellets are conveyed across the injection molder screw 6, the high temperatures, shear and pressure generated by the screw transforms the solid pellets into a melted product that can be injected into the mold 7 and take form. The melted product travels through the sprue and/or manifolds, runners and/or nozzles and then the cavities to form the final product shape. Once the shot is complete, the injection screw will retract and refill with melted product for the next shot.

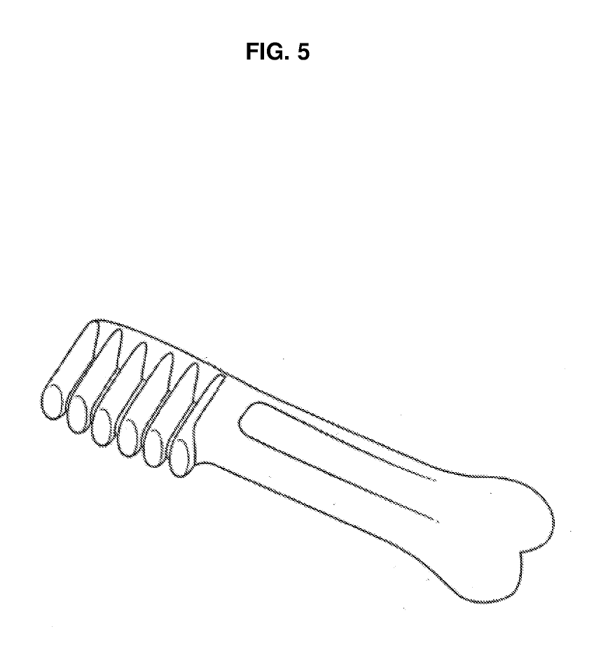

As the injection molder is being filled, the formed products in the cavities are either cooled or heated as required to cool and/or set the products. Once the desired cooling or set time is achieved, the mold opens and the products are released from the cavities through ejector pins on the backside of the product. The molded products fall on to a mechanical conveyor, which are subsequently collected for cooling. If runners are present, they are removed and the molded products are laid out on a cooling table to allow the temperature of the bones to reach ambient temperature prior to packaging. An exemplary molded pet chew is shown in FIG. 5.

The supercritical fluid can be added to the process at several points. For example, the supercritical fluid may be fed into the extruder barrel during the extrusion process. Other variations will add the supercritical fluid to the mixed material passing from the extruder into the injection molding apparatus. Other variations will add the supercritical fluid to the material in the injection molder.

The pressure and temperature parameters are desirably controlled such that the supercritical nature of the fluid is maintained as desired, and/or that cell nucleation and expansion are facilitated.

Exemplary injection molding process parameters for the formation of the molded products are shown in TABLE 1.

TABLE 1
Exemplary injection molding process parameters

| Parameters | Units | Range |
|---|---|---|
| Feed Rate | Kilogram/hour (kg/hr) | 20-250 |
| Barrel Temperatures | Degrees Fahrenheit | 60-350 |
| Injection Speeds | Inches/Second (in/s) | 1-10 |
| Injection Pressures | Pounds per square inch (psi) | 5000-25000 |
| Injection Times | Seconds (s) | 3-40 |
| Stroke | Inches/second (in/s) | 0.5-8.0 |
| Screw Speed | Revolutions per minute (RPM) | 50-300 |
| Mould Temperatures | Degrees Fahrenheit | 140-350 |
| Cooling/Set Times | Seconds (s) | 10-175 |

It is also possible to simply admix the ingredients for the formulation and go directly to the injection molder so long as the parameters are controlled to achieve thermoplasticization of the formulation.

Chews and treats of the present invention can be formed such that they are of any desired size and/or shape. In preferred forms, the volume ranges from 0.15-8 cubic inches, the width ranges from 8-25 mm, the height ranges from 14-40 mm and the length ranges from 52-153 mm.

Typical water activity will range between 0.45-0.65, more preferably between 0.48-0.62, and still more preferably between 0.52-0.59.

Contacting the pet product compositions with a supercritical fluid will impart many beneficial aspects to the finished pet products. For example, treats and chews that have been contacted with a supercritical fluid exhibit increased oral care properties due to the increased interaction with the surface structure as well as the fragmented inner surface of the foamed product. This increased oral care will be evident throughout the mouth including the teeth, gums, inside of the cheeks, and palate of the animal that consumes the treat or chew.

Additionally, the surface of the pet product will have a rougher or more varied texture than a similar pet product that has not been subjected to or contacted with a supercritical fluid. This is due to the presence of the microbubbles that are formed by the supercritical fluid. Additionally, when the bubbles fracture, they provide an increased surface area with which the product fragments can contact and interact with the mouth and the parts therein of the animal that consumes the treat or chew.

The size, concentration and distribution of bubbles will affect each of these properties such that as bubble concentration and distribution increase, the beneficial impact will also increase. Further, due to the improved structure, friction is also increased on the downward bite and upward pull. In general, the cells (or bubbles) will have an average diameter between 0.05 to 200 μm, more preferably between 0.1 to 150 μm, even more preferably between 1 to 100 μm, and still more preferably between 2 to 80 μm. Preferably, the cell distribution within the pet product will be substantially uniform. Substantially uniform in this context will generally mean that cell density will not vary more than 10%, or more than 7%, or more than 5%, or even more than 3%, over any section of the treat or chew that comprises at least 10% of the total volume of the pet product. Cell density will generally be greater than 2×10⁴ cells/cc, and can be between 2×10⁶ to 2×10¹⁶ cells/cc, or between 2×10⁷ to 2×10¹⁵ cells/cc, or between 2×10⁸ to 2×10¹⁴ cells/cc, or between 2=10⁹ to 2×10¹³ cells/cc, or between 2×10¹⁰ to 2×10¹² cells/cc. Such cell densities and cell sizes will result in pet products having fewer calories and less mass per product when compared to pet products that have not undergone contact with a supercritical fluid. For example, pet products having a reduction of at least 5%, or at least 10%, or at least 15%, or at least 20%, or even at least 25%, in both calories and mass when compared to conventional pet products may be provided. Less pet product composition is thus used to form each product, and cost savings are additionally provided.

Other advantages of the present pet products include greater digestibility in comparison with treats or chews having a similar composition, but which have not been contacted with a supercritical fluid. Due to the greater digestibility, stools will also be improved. Finally, the pet products will have fewer calories in comparison to similar sized and formulated pet products due to the microbubbles created by the supercritical fluid.

One example of a method of making the pet products involves supplying a gas, in a non-critical state, to a high pressure chamber through a high pressure valve.

The pressure within the high pressure chamber is either set to a point higher than the critical point of the gas utilized or the chamber is pressurized through a compressor to a point higher than the critical point. Similarly, the temperature within the high pressure chamber is either set to higher than the critical point for the gas being utilized or the chamber is heated to such a point. Once the pressure and the temperature have exceeded the respective critical points of the utilized gas, the gas is transformed into a supercritical liquid. The temperature of the chamber is controlled, e.g., by selective heating and cooling so that the temperature within the high pressure chamber can be adjusted and maintained to maintain the utilized liquid/gas in a supercritical state.

Critical temperatures and pressures are known in the art for each fluid. For example, the critical temperature and pressure for carbon dioxide are 31.1° C. 1071.3 psi, respectively, and temperatures and pressures at or above these are utilized in order to maintain carbon dioxide in a super critical state. The critical temperature and pressure for nitrogen are −147° C. and 493 psi, respectively. Higher temperatures and pressures can be utilized and can be used to impact the characteristics of the pet product.

A pet product composition is then placed in the high pressure chamber having the desired supercritical fluid therein. The pet product composition is then left in the high pressure chamber for a period of time that is dependent on the thickness, density, and hardness of the composition as well as on the desired amount of cell nucleation and eventual foaming. The size and density or concentration of the cells within the pet product can be adjusted by manipulating the residence time of the pet product within the high pressure chamber as well as the hardness or permeability of the treat. Those of skill in the art will further understand that the desired amount of reduction in both calories and mass will be directly related to the amount of supercritical fluid used in the process, and the temperature and residence time in the high pressure chamber.

Once the desired amount of time has passed, the high pressure chamber is opened and the composition is removed therefrom. Cell nucleation and expansion, or foaming, then occur within the composition as a result of the pressure and temperature rapidly assuming ambient room conditions after removal from the high pressure chamber. The foaming time can range from 1 second to 15 minutes, or from 30 seconds and 10 minutes, or from between 45 seconds and 5 minutes, or from 1 minute and 3 minutes.

The process of making the pet products can be operated continuously, or batch-wise. For a continuous process, an extruder can be used to supply the pet product composition to the high pressure chamber in the form of a continuous sheet. The sheet of the pet product composition is then advanced through the chamber by a series of rollers at a rate that will produce the desired level of foaming of the material. The rollers may be heated, cooled or maintained at a substantially constant temperature. As the sheet of pet product composition travels through the chamber, the pet product can become saturated with the supercritical fluid. Once the saturated pet product composition exits the chamber, it is exposed to ambient temperatures and pressures which causes nucleation and expansion of cells within the saturated composition. Further nucleation, expansion and/or foaming can be caused by heating the composition.

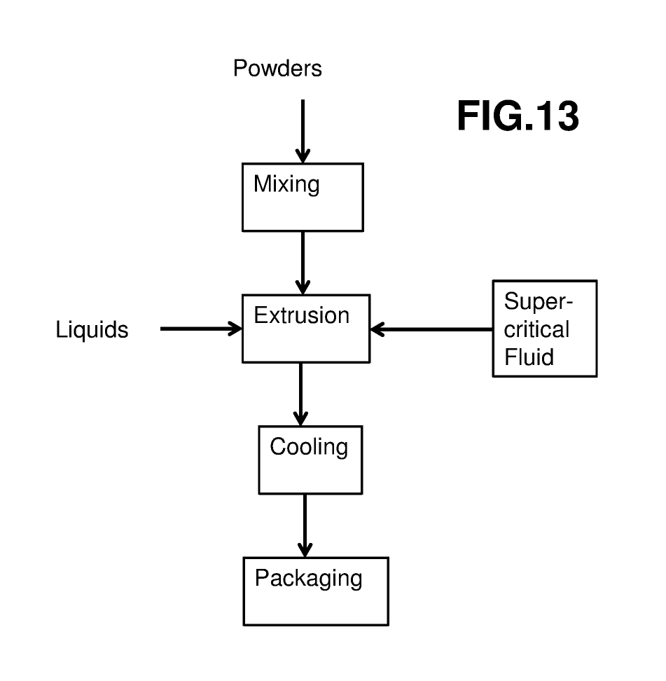

The supercritical fluid may be provided to the system at any selected point, and may, e.g., be injecting supercritical fluid into an extruder during an extrusion process, wherein conditions within the extruder are designed to maintain the fluid in its supercritical state. In such embodiments, the mixing screw of the extruder aids in forming a solution of extrudate and supercritical fluid. Shear created by the rotation of the mixing screw stretches the supercritical fluid bubbles in the direction of the shear and these stretched bubbles are broken by the rotation of the screw to create progressively smaller bubbles. Using irregular blades in the mixing screw can facilitate changes in the orientation of the gas/extrudate interface relative to the shear streamlines to thereby increase the efficiency of the laminar mixing occurring therein. When the saturated composition exits the barrel of the extruder, it is supplied to a die or mold and then conveyed to a chamber adjusted to, or maintained at, conditions subcritical for the gas being used to induce cell nucleation and expansion within the pet product composition. Such a process is shown in FIG. 13.

For example, the extruder could be connected to a chamber that included both heat and pressure controls therein such that the individual heat and/or pressure changes could be slowly adjusted to achieve a desired cell nucleation and expansion characteristic. Or, sub-supercritical gas could be injected into an extruder during an extrusion process wherein the temperature and pressure are brought to a point that surpasses the levels required to transform the gas into a supercritical fluid. The gas could be injected into the extruder either before or after the point at which the temperature and/or pressure was above the critical level.

The gas/extrudate mix may be supplied to a static mixer which continually changes the orientation of the gas/extrudate interface relative to the shear streamlines. The diameter of the static mixer is desirably small so as to increase the flow rate and overcome the effect of surface tension of the gas bubbles.

The saturated or expanded pet product composition can be formed using any known process, and may typically be formed using any type of molding process. The mold can be designed to maintain the supercritical conditions (e.g. with air compression or physical mold compression) and upon expansion of the mold cavity and the pressure therein is reduced rapidly, cell growth occurs.

For example, stamp-molding may be used, and in such embodiments, the stamp molding apparatus could be housed within a pressurizable chamber maintained at supercritical conditions for the gas being used. A supercritical fluid is supplied to the chamber together with pet product composition, which is positioned between the mold cavity and the reciprocating mold body. Once the supercritical fluid and pet product compositions have been in contact for a time sufficient to saturate the pet product composition with the supercritical fluid, the reciprocating mold body presses the material into the mold cavity to make a molded product in the shape of the mold cavity.

The pressure and temperature within the chamber can be adjusted/reduced to sub critical, preferably ambient conditions immediately prior to, simultaneously with, or just after the pet product composition is pressed into the cavity. When the pressure and temperature conditions are reduced simultaneously with the forming of the molded product, cell nucleation and cell expansion within the material occur simultaneously with the molding of the product. In such an embodiment, the product has a supermicrocellular structure and the product is both foamed and formed at room (ambient) temperature in one overall operation. Accordingly, expansion of the mold provides a molded and foamed article having the small cell sizes and high cell densities desired.

Desirably, mixing within the extruder, high pressure chamber and/or static mixer and subsequent release of super critical conditions, will result in the gas and pet product composition extrudate becoming a single-phase solution as the gas diffuses into the extrudate therein. The gas concentration in the single-phase gas/extrudate solution is substantially uniform throughout the solution and the solution is effectively homogeneous. In other embodiments, wherein a pet product with a homogeneous distribution of cells is not desired or required, less mixing may be desired.

By using a mixing screw for providing a shear field which produces a laminar flow of the mixed materials and then by using both a static mixer having small diameter mixing elements and a selected number of such mixing elements and a diffusion chamber, saturation of the extrudate material with supercritical fluid occurs. The time period required to provide such saturation can be reduced from that required in the embodiments of the invention discussed previously so that it is possible to achieve continuous operation at relatively high production rates that would not be possible when longer saturation times are needed.

### Systems

In another aspect, a pet product is provided by a system that includes an extruder operatively connected to an injection molding chamber. A pet product composition is supplied to the inlet of the extruder, advanced through the extruder to an enclosed passageway connected to the molding chamber, and through the passageway into the molding chamber. A super critical fluid is introduced into the process such that the enclosed passageway receives a non-nucleated, homogeneous, fluid, single-phase solution of the pet treat composition and super critical fluid, and advances the solution as a fluid stream within the passageway in a downstream direction from the inlet end toward the molding chamber.

The passageway may further include a nucleating pathway in which super critical fluid in the single-phase solution passing therethrough is nucleated. The nucleating pathway is constructed to include a polymer receiving end which receives a homogeneous fluid, single-phase solution of a polymeric material and a non-nucleated super critical fluid, a nucleated polymer releasing end constructed and arranged to release nucleated polymeric material, and a fluid pathway connecting the receiving end to the releasing end. Optionally, the polymer releasing end can define an orifice of the molding chamber or the polymer releasing end can be in fluid communication with the molding chamber. The nucleating pathway is constructed to have length and cross-sectional dimensions such that, the system is capable of subjecting fluid polymer admixed homogeneously with super critical fluid to a pressure drop rate while passing through the pathway of at least about 0.1 GPa/sec, or at least about 0.3 GPa/sec, or at least about 1.0 GPa/sec, or at least about 3 GPa/sec, or at least about 10 GPa/sec, or at least about 100 GPa/sec. The nucleating pathway can also be constructed to have a variable cross-sectional dimension such that a fluid polymer flowing through the pathway is subjected to a variable pressure drop rate and/or temperature rise.

The system may include a molding chamber constructed and arranged to contain nucleated pet product composition/super critical fluid solution at an elevated pressure in order to prevent cell growth at the elevated pressure. The pressurized molding chamber can be fluidly or mechanically pressurized in order to contain the nucleated solution at such an elevated pressure. After reduction of the pressure on the pressurized molding chamber, the solution can solidify into the desired shape.

The system can also include a second extrusion barrel connected in tandem with the first barrel where the second barrel has an inlet designed to receive the fluid non-nucleated mixture and has a screw mounted for reciprocation within the barrel.

The pet product will desirably have at least 50,000, or at least 75,000, or at least 100,000 or at least 125,000, or at least 150,000, or at least 175,000, or at least 200,000, or at least 250000, or at least 275000, or at least 300,000, or at least 325,000, or at least 350,000 cells, or at least 360,000 cells, or at least 375,000 cells, or at least 400,000 cells, or at least 500,000 cells per cubic centimeter. The pet product will desirably have an average cell count of from about 300,000 to 400,000 cells per cubic centimeter. The number of cells of the pet product will desirably be at least 2, 3, 5, 10, 15, 20 or 25 times as many cells as a pet product that does not include a supercritical fluid therein, or a pet product that was processed without the use of super critical fluid.

The average cell volume may be from about 50,000 to 200,000 μm³, or from 100,000 to 150,000 μm³. An average cell volume of about 107,000 μm³ has been found particularly useful in some applications. The average cell volume can be 80% smaller, 70% smaller, 60% smaller, 50% smaller, 40% smaller, 30% smaller, and 20% smaller than the cell volume of a pet product that does not include a supercritical fluid therein or a pet product that was processed without a supercritical fluid.

The product has a surface roughness greater than a pet chew that does not include a supercritical fluid therein. For purposes of the present invention, surface roughness refers to the surface texture of the interior cross-section area, whereas this area makes surface contact with a tooth during the downward bite and upward pull involved with a chewing action. The surface roughness is preferably measured as an Ra (μm) value, whereas Ra is the arithmetic average of the absolute values of the profile height deviations from the mean line, recorded within the evaluation length. In other terms, Ra is the average of a set of individual measurements of a surfaces peaks and valleys.

However, the surface roughness can be measured using any known measurement, including but not limited to, Sq, the standard deviation of the height of distribution or in other terms, RMS surface roughness; Ssk, the skewness of the height distribution; Sku, the kurtois of the height distribution which qualifies flatness; Sp (μm), the height between the highest peak and the mean plane; Sv (μm), the depth between the mean plane and the deepest valley; Sz (μm), the height between the highest peak and the deepest valley; or Sa (μm), the arithmetical mean height or in other terms, the mean surface roughness. Preferably, the Ra value of the product of the present invention is from about 4 to 15, where values such as, but not limited to, 4.8, 5, 5.1, 5.5, 5.8, 5.9, 6, 6.3, 7, 7.6, 8, 9, 10, 11, and 11.8 are envisioned as the Ra value of the product of the present invention. Preferably the Ra value of the product of the present invention is greater than that of a pet chew that does not include a supercritical fluid therein. In a preferred embodiment, the Ra value of the product of the present invention is at least 1.5 to 4 times the Ra value of a pet chew that does not include a supercritical fluid therein, more preferably at least 2 to 3 times the Ra value of a pet chew that does not include a supercritical fluid therein.

The pet product desirably has an average coefficient of friction of about 0.136±0.001 to 0.235±0.049, where the average coefficient of friction may also be 0.198±0.063, 0.138±0.001, and values in-between. The formula of the pet chew of the present invention can be altered, as known by those skilled in the art, such that the coefficient of friction, elasticity, flexibility and hardness can be modified.

The hardness of the pet product is preferably less than a pet product that does not include a supercritical fluid therein. The hardness and/or stiffness can be expressed using Vickers, MPa, Young's Modulus (MPa) and Max. Depth (nm). When the hardness of the pet product is measured using the Vickers analysis, the hardness ranges from about 0.003 to 0.02, more preferably from about 0.005 to 0.1, where values such as, but not limited to, 0.0061±0.0005, 0.0074±0.0005, 0.0099±0.0021, and 0.109±0.0005 are envisioned. In an embodiment using the Young's Modulus [Mpa] stiffness value, the value for the pet product of the present invention is preferably 20 or less, more preferably, from about 2 to 20, where values such as, but not limited to, 3, 3.8, 4, 5, 6, 7, 8, 8.1, 8.5, 9, 10, 11, 12, 13, 14, 15, 16, 17, 18, and 19 are also envisioned. Preferably, the Young's Modulus of the product of the present invention is about 20% to 90% less than the Young's Modulus [Mpa]of a pet product that does not include a supercritical fluid therein., where values such as, but not limited to 30% less, 40%, less, 50% less, 60% less, 70% less, and 80% less are envisioned.

The tensile strength of the product of the present invention is preferably less than that of a pet product that does not include a supercritical fluid therein. Preferably, the average tensile strength for the total area of the product of the present invention is preferably about 15% to 50%, of the tensile strength for a pet product that does not include a supercritical fluid therein. In a most preferred embodiment, the average tensile strength for the total area of the product of the present invention is about 34% of the tensile strength for a pet product that does not include a supercritical fluid therein. Allowing the treats to age, the average tensile strength of the total area of the product of the present invention is preferably from about 30% to 60% of the average tensile strength of a pet product that does not include a supercritical fluid therein. In a most preferred embodiment, the average tensile strength for the total area of the aged product of the present invention is about 47% of the tensile strength for a pet product that does not include a supercritical fluid therein. Preferably, the peak force of the product of the present invention is preferably from about 4-10, where a preferred value is about 5.5. The peak force value of the product of the present invention is preferably about half of the peak force value of a pet product that does not include a supercritical fluid therein. Preferably, the distance to break for the product of the present invention is preferably from about 40-53, where a most preferred value is about 42. Preferably, distance to break is about 15-30% less than that of a pet product that does not include a supercritical fluid therein, most preferably the distance to break is about 25% less than that of a pet product that does not include a supercritical fluid therein. Preferably, the ratio of peak distance to peak force is higher for the product of the present invention when compared to a pet product that does not include a supercritical fluid therein. Preferably, the ratio of peak distance to peak force is about 6:1 to 8:1, when compared to 4:1 of a pet product that does not include a supercritical fluid therein. Thus, one embodiment of the present invention allows for easier tooth penetration than a pet product that does not include a supercritical fluid therein.

In another aspect, meat, dried meat, or meat slurry is added into the polymeric treat through a controlled means.

The temperature and pressure of the environment in which the supercritical fluid is used is desirably controlled to maintain the supercriticality of the fluid as long as the same is desired. Such temperature and pressure control systems are well known in the extruder and compression molding arts. For example, heating and cooling elements, blankets, bands, rings, and the like can be utilized. Similarly, pressure conditions can be controlled in any conventional manner including by adjusting the screw speed of the extruder, adjusting barrel diameters, applying an external pressure source, and the like. In some forms, the temperature and pressure can be separately controlled apart from the extrusion or molding process. Alternatively, temperature and pressure conditions can be controlled as a part of the overall processes. Preferably, pressure and temperature monitors are positioned in the correct locations in order to ensure that supercritical fluid is maintained in the supercritical state when desired and released from the supercritical state in a controlled and deliberate manner.

### EXAMPLE 1

The following ingredients were mixed to provide an inventive pet product composition, specifically by first combining the liquid ingredients, combining the dry ingredients, and then by mixing the combined liquid and combined dry ingredients together:

TABLE 2

| Ingredient | Liquid or Powder | Weight Percent |
|---|---|---|
| Fibrous Protein | Powder | 30-50 |
| Gelling Protein 100-200 Bloom | Powder | 15-25 |
| Glycerine | Liquid | 15-25 |
| Water | Liquid | 5-15 |
| Hydrogenated Starch Hydrolysate | Liquid | 0-15 |
| Flavor Enhancer | Powder | 1-10 |
| Fat | Liquid | 1-10 |
| Nutrients | Powder | 3-7 |
| Preservative | Powder | 0.05-0.55 |
| Natural Colorant | Powder | 0.005-0.045 |

The natural colorant is a combination of turmeric and anthocyanins. The turmeric is provided in powder form and the anthocyanins are derived from red cabbage and/or blood orange. The water activity of the final products ranges from 0.2-0.85. In addition, individual ingredient levels and ratios of liquid to powder may be modified to obtain various final product textures. Further, replacing ingredients with alternatives may also result in different final product textures. For example, the use of 200-bloom gelatin instead of 100-bloom gelatin would result in a firmer product.

### EXAMPLE 2

The following ingredients were mixed to provide an inventive pet product composition:

TABLE 3

| Ingredients | Weight Percent |
|---|---|
| Wheat Protein Isolate | 17 |
| Soy Protein Isolate | 14 |
| Sodium Caseinate | 8 |
| Glycerin | 17 |
| Hydrogenated Starch Hydrolysate | 9 |
| Gelatin (100 Bloom) | 17 |
| Water | 7 |
| Vegetable Oil | 3 |
| Flavor/Nutrients/Preservatives/Natural | 8 |
| Colorant | |

### EXAMPLE 3

The following ingredients were mixed to provide an inventive pet product composition:

TABLE 4

| Ingredients | Weight Percent |
|---|---|
| Wheat Protein Isolate | 18 |
| Soy Protein Isolate | 15 |
| Sodium Caseinate | 8.5 |
| Glycerin | 17.5 |
| Hydrogenated Starch Hydrolysate | 2.8 |
| Gelatin (100 Bloom) | 18.5 |
| Water | 9.2 |
| Corn Oil | 1.5 |
| Flavor/Nutrients/Preservatives/Natural | 9 |
| Colorant | |

### EXAMPLE 4

The following ingredients were mixed to provide an inventive pet product composition:

TABLE 5

| Ingredients | Weight Percent |
|---|---|
| Wheat Protein Isolate | 18.8 |
| Soy Protein Isolate | 15.6 |
| Sodium Caseinate | 8.9 |
| Glycerin | 15.8 |
| Hydrogenated Starch Hydrolysate | 2.5 |
| Gelatin (100 Bloom) | 19.3 |
| Water | 8.3 |
| Vegetable Oil | 1.4 |
| Flavor/Nutrients/Preservatives/Natural | 9.4 |
| Colorant | |

The formulations shown in Tables 2-5 are used to produce a pet product or treat as follows. First, the liquid ingredients, not including the oil, are blended together and maintained below a desired temperature, preferably below 50° F. (−10° C.). The dry ingredients are also added to a mixer and blended together. The liquid ingredient mixture and the oil are then added to the dry ingredient blend in multiple stages to produce a mash. The multiple stages are used in order to prevent pooling and to distribute the liquid evenly. After all of the ingredients are added and evenly mixed together, the resultant mash is transferred to a surge tank for later conveyance to the injection molders or it is directly conveyed to the injection molders after the mixing process is complete. A supercritical fluid is added or injected into the melt and the temperature and pressure parameters are controlled to maintain the supercritical state of the fluid until cell nucleation and expansion are desired whereupon the temperature and pressure parameters are modified or manipulated to produce a desired bubble size and bubble concentration for the final product. This manipulation can be done prior to or during the actual injection molding process.

Product performance of the pet product is measured against a number of criteria including plaque and tartar reduction, breath freshening, lasting time, palatability as measured by paired preference, solubility, textural attributes including hardness, density, elasticity, friability, water absorption capacity, and speed of solubilization.

Texture measurements were performed with a TA.HDi Texture Analyzer (Texture Technologies Corp., Scarsdale, N.Y.) equipped with a 250-500 kg load cells. A 5 mm diameter cylindrical probe was used for uniaxial compression or puncture tests, and the tests were conducted at a room temperature of 25° C. Data was collected using the Texture Expert software (version 2.12) from Texture Technologies Corp. Two different uniaxial compression or puncture tests were run. These tests were selected because they best resemble the biting and chewing of the test samples by dogs.

The compression analysis parameters are as follows. Work (W) is defined as an estimate of work; and therefore shows the toughness of the product. A tough product will have a higher work value than a less tough product. The area shows the “force” or load that must be applied to the product to cause it to break. The area under the curve represents toughness. The expressed “Area” units come from the multiplication of y-axis per x-axis as N*mm. To convert “Area” to Work-W-(F/d) multiply by 0.1020408 m.sup.2/mm/s.sup.2.

The Max Force (N) is defined as the maximum amount of force needed to overcome the product's hardness. Usually a hard product will be associated with high ordinate (y-axis) values. The expressed “Force” unit derives from a direct association with mass weight in kg. To convert “Force” to “Max Force”-N-multiply by 9.81 m/s.sup.2 (the acceleration of gravity).

Travel (mm) is represented as the point (distance) at which the peak force is reached. Thus it emulates the resistance of the product as a combination between toughness and hardness, in addition to elasticity, attributed to a measurement of how far the probe has traveled to reach the maximum force. Larger travel numbers are indicative of more elastic products. Resistance to breaking is directly proportional to travel values.

Linear Distance (mm) is calculated by measuring the length of an imaginary line pulled taunt joining all the trajectory points. This measure describes crumbly verses cohesive product attributes. It is a direct assessment of brittleness where a brittle product will produce more sharp peaks, resulting in a higher linear distance.

The values of hardness, toughness, elasticity, toughness were determined using whole product samples. A base platform, as observed with the TA.HDi, provided by Texture Technologies, was used to measure force/distance. An exemplary product sample that was made and tested is shown in FIG. 5.

The sample was centered on the platform such that the knife will contact one location along the sample bone length at a time. The chosen locations included the brush head. The location is contacted with the knife at a 90° angle while the sample is laying on its side placed on a flat platform surface. The brush head, the joint of the shaft to the brush head and the knuckle at the end of the shaft of a pet chew are clearly visible in FIG. 5.

### Solubility

The in vitro measurement of solubility/digestibility of a pet chew may be used to indicate the amount of the pet chew that would solubilize or be digested in the gastrointestinal tract of a pet, and particularly a dog. The test performed is based on a portion or whole piece of a pet chew product. A particular size portion or piece, e.g., a 32-gram pet chew portion, may be used so that different formulations can be accurately compared. The outcome is expressed as percent (%) in vitro disappearance (IVD). The solubility measurement is performed by subjecting a specific amount of product to a number of solutions which represent the stomach and intestinal environments of a pet. Generally, the stomach environment is relatively acidic and the intestinal environment is relatively more alkaline compared to the stomach. After subjecting the product to these environments, any product left is filtered and dried. This leftover product is weighed and compared with the weight of the initial product. Percent IVD is the percentage of the weight of the dissolved product in comparison to the weight of the initial product. The solubility test is further described below.

### Solutions Utilized

Phosphate Buffer, 0.1M, pH 6.0 Solution: 2.1 grams of sodium phosphate dibasic, anhydrous, and 11.76 grams of sodium phosphate monobasic, monohydrate were dissolved in a 1 liter volumetric flask and brought up to volume with distilled/deionized (dd) water.

HCl Solution: 17.0 ml concentrated HCl was added to a 1 liter volumetric flask containing 500 ml dd water and brought up to volume with dd water. When 100 ml of HCl:pepsin is added to 250 ml of phosphate buffer, the pH should be close to 2.0. One way to achieve this is to use 850 ml of 0.1 N HCl+150 ml of 1 N HCl to make 1000 ml of HCl stock solution. When 100 ml of HCl:pepsin is added to 250 ml phosphate buffer, the pH of the solution is about 1.9-2.0.

HCl:Pepsin Solution: The appropriate amount of pepsin (Sigma P-7000, pepsin amount is dependent on sample size being tested. 0.01 gram pepsin per 1 gram sample must be obtained in the final mixture at Step 6 of the procedure. For example 0.3 gram pepsin would be used for 30 grams sample) was placed in a 1 liter volumetric flask and brought up to volume with the HCl solution made above.

Chloramphenicol Solution: 0.5 gram chloramphenicol (Sigma C-0378) was brought up to volume in a 100 ml volumetric flask with 95% ethanol.

Sodium Hydroxide Solution, 0.5N: 20 grams NaOH was brought up to volume in a 1 liter volumetric flask with dd water.

Phosphate Buffer, 0.2M, pH 6.8 Solution: 16.5 grams of sodium phosphate dibasic, anhydrous, and 11.56 grams of sodium phosphate monobasic, monohydrate were dissolved in a 1 liter volumetric flask and brought to volume with distilled water.

Pancreatin:Phosphate Buffer Solution: The appropriate amount of porcine pancreatin (Sigma P-1750) enzyme amount is dependent on sample size being tested. 0.05 gram porcine pancreatin per 1 gram sample is to be obtained in the final mixture. For example, 1.5 grams of pancreatin would be used for 30 gram samples, and is dissolved in a 500 ml volumetric flask and brought up to volume with 0.2M, pH 6.8 phosphate buffer solution described above.

Procedure

1. Place numbered pieces of dacron fabric in a 57° C. oven overnight and weigh the next day.

2. Weigh samples into Erlenmeyer flasks. (Weigh additional sample to dry as a control along with residue to account for moisture loss during % IVD calculation). Add 250 ml 0.1M pH6.8 Phosphate Buffer Solution to each flask.

3. Add 100 ml HCl:Pepsin Solution to each flask. Check that the pH of the mixture is about 2. Adjust with HCl if needed.

4. Add 5 ml Chloramphenicol Solution to each flask.

5. Stopper the flasks. Mix gently. Incubate at 39° C. for 6 hours. Mix on a regular basis using a shaking water bath, set at a speed that causes the samples to constantly move in the flask while keeping the products submerged in the solution.

6. After incubation, add enough 0.5N Sodium Hydroxide Solution to each flask to reach a final pH of 6.8 for the mixture.

7. Add 100 ml Pancreatin: Phosphate Buffer Solution to each flask. Mix gently.

8. Stopper the flasks. Incubate at 39° C. for 18 hours. Mix on a regular basis using a shaking water bath, set at a speed that causes the samples to constantly move in the flask while keeping the products submerged in the solution.

9. Filter the sample through tared pieces of dacron fabric from Step 1. Rinse with three times with dd water. Maintain at 57° C. until constant weight is reached.

10. Record pH at the following stages:
a. At step 4.
b. After 6 hours of digestion.
c. After addition of NaOH solution at step 7.
d. After addition of pancreatin:phosphate buffer solution.
e. After 24 hours.

Calculations:

$$Residue Weight = ( Filter + Sample weight after incubation ) - Dry filter weight$$

$$\% IVD = 1 - \frac{( Sample residue weight ) - ( Blank residue weight )}{Dry matter weight} \times 100$$

In certain embodiments, the pet chew composition possesses a solubility of at least 60% IVD, preferably at least 70% IVD and more preferably at least 75% IVD based on a maximum 32-gram piece (if the pet chew is less than 32 grams then typically a single chew product of a given gram weight will be used. It is not recommended to use a piece larger than 32 gram for a realistic reading. Of course one of ordinary skill will recognize that the mass of the pieces analyzed needs to be substantially equivalent to make a comparison of the solubility numbers). While the solubility of the pet chew of this invention may be close to 100%, it generally will be in the range of about 60 to about 95% IVD. The solubility of a pet chew made from the formulation of Example 2 by extrusion and injection molding as described herein was about 85% IVD.

When the pet product formulation is exposed to supercritical fluid, the IVD of the resulting pet chew has an increased IVD in the range of about 5 to about 10% when compared to a pet chew that does not include a supercritical fluid therein. The increased IVD of the pet chew of the present invention could also have an IVD range that is 5-25% higher, including ranges such as, but not limited to, 5-15%, 5-20%, 5-25%, 10-25%, 15-25%, and 20-25%. Generally, as the IVD of the pet chew of the present invention increases as the amount of supercritical fluid increases.

### EXAMPLE 5

### Analysis of Surface Roughness

The samples were prepared by removing the ends of the treats were using a standard paring knife, exposing the cross section area of the control and experimental treats. The length was between 2-3 centimeters.

Equipment: Nanovea ST400 Optical Profiler

Measurement Parameters:
Probe=300 μm/MG7
Acquisition rate=1000 Hz
Averaging=1
Measure surface=5 mm×2 mm
Step size=2.5 μm×2.5 μm
Scanning Mode =Constant speed
Scan Time per line=00:40:19

Probe Specifications:
Z Resolution=12 nm
Z Accuracy=60
Lateral Resolution=2.6 μm

The axial chromatism technique utilized a white light source, where light passed through an objective lens with a high degree of chromatic aberration. The refractive index of the objective lens will vary in relation to the wavelength of the light. In effect, each separate wavelength of the incident white light will re-focus at a different distance from the lens (different height). When the measured sample is within the range of possible heights, a single monochromatic point will be focalized to form the image. Due to the confocal configuration of the system, only the focused wavelength will pass through the spatial filter with high efficiency, thus causing all other wavelengths to be out of focus. The spectral analysis was done using a diffraction grating. This technique deviates each wavelength at a different position, intercepting a line of CCD, which in turn indicates the position of the maximum intensity and allows direct correspondence to the Z height position.

Unlike the errors caused by probe contact or the manipulative Interferometry technique, White light Axial Chromatism technology measures height directly from the detection of the wavelength that hits the surface of the sample in focus. It is a direct measurement with no mathematical software manipulation. This type of measurement was used on a number of pieces of the treat of the present invention in order to determine the surface roughness of the treat.

TABLE 6

| | | | 5% Shot Size | | 10% Shot Size | | 20% Shot Size | | 10% Shot Size | |
|---|---|---|---|---|---|---|---|---|---|---|
| | | | Reduction with | | Reduction with | | Reduction with | | Reduction with Carbon | |
| | Control | | Nitrogen | | Nitrogen | | Nitrogen | | Dioxide | |
| Height | Sample | Sample | Sample | Sample | Sample | Sample | Sample | Sample | Sample | Sample |
| Parameters | A | B | A | B | A | B | A | B | A | B |
| Sq (μm) | 7.518 | 6.32 | 15.99 | 23.32 | 17.97 | 23.69 | 12.37 | 17.28 | 16.96 | 22.51 |
| Ssk | -0.07316 | 0.2692 | 0.8387 | 0.03318 | 0.4029 | 0.4484 | -1.713 | -0.8773 | -0.2469 | 0.1716 |
| Sku | 3.742 | 4.288 | 4.372 | 2.629 | 2.876 | 3.267 | 8.704 | 6.357 | 3.95 | 3.61 |
| Sp (μm) | 40.5 | 48.42 | 78.97 | 87.91 | 73.22 | 96.92 | 83.27 | 81.46 | 73.35 | 90.57 |
| Sv (μm) | 51.26 | 43.36 | 66.23 | 86.3 | 69.84 | 106.5 | 89.06 | 148 | 96.69 | 98.8 |
| Sz (μm) | 91.77 | 91.79 | 145.2 | 174.2 | 143.1 | 203.5 | 172.3 | 229.4 | 170 | 189.4 |
| Sa (μm) | 5.766 | 4.845 | 12.39 | 18.7 | 14.4 | 19.03 | 8.572 | 13.13 | 13.15 | 17.29 |
| Surface | | | | | | | | | | |
| Roughness | | | | | | | | | | |
| Ra (μm) | 3.508 | 4.28 | 6.346 | 5.131 | 11.81 | 5.084 | 4.846 | 5.894 | 7.603 | 5.506 |

### EXAMPLE 6

### Determination of Coefficient of Friction

Sample Preparation: The ends of the treats were cut off using a standard paring knife, exposing the cross section area of the control and experimental treats. The length was between 2-3 centimeters.

Equipment: Nanovea TRB

Settings:
Load=15 N
Duration of test=20 min.
Speed rate=100 rpm
Length=5.5 mm
Revolutions=2000
Ball Diameter=6 mm
Ball Material=Steel
Substrate Material=Sample

Environmental Conditions:
Lubricant=N/A
Atmosphere=Air
Temperature=24° C.
Humidity=40%

The instrument base was first leveled in the horizontal position by screwing or unscrewing the adjustable rubber pads at each corner. A ball-holder containing a 3 or 6 mm diameter ball was held in the load arm and placed at a height that allow the tribometer arm to be leveled horizontally when resting on the sample to ensure that normal load would be applied vertically. The arm was then balanced with counter weights to ensure that the arm and ball holder initially apply no force on the sample surface. Finally, weights corresponding to the load required for the test arm were finely placed on the arm over the ball holder. Through software, the test was then launched and the test was performed at a specified speed for a specified duration, and the frictional force is recorded over times.

TABLE 7

| | Max COF | Min COF | Average COF |
|---|---|---|---|
| Control | 0.171 ± | 0.058 ± | 0.120 ± |
| | 0.005 | 0.011 | 0.006 |
| 5% Shot Size | 0.279 ± | 0.092 ± | 0.198 ± |
| Reduction with | 0.073 | 0.043 | 0.063 |
| Nitrogen | | | |
| 10% Shot Size | 0.320 ± | 0.126 ± | 0.235 ± |
| Reduction with | 0.082 | 0.031 | 0.049 |
| Nitrogen | | | |
| 20% Shot Size | 0.188 ± | 0.031 ± | 0.138 ± |
| Reduction with | 0.010 | 0.006 | 0.001 |
| Nitrogen | | | |
| 10% Shot Size | 0.199 ± | 0.055 ± | 0.136 ± |
| Reduction with | 0.005 | 0.006 | 0.001 |
| Carbon Dioxide | | | |

### EXAMPLE 7

### Determination of Hardness

Sample Preparation: The ends of the treats were cut off using a standard paring knife, exposing the cross section area of the control and experimental treats. The length was between 2-3 centimeters.

Equipment: Nanovea Nano Module

| Machine Parameters: | Control Sample* | Test Samples |
|---|---|---|
| Maximum force (mN) = | 10 | 1 |
| Loading rate (mN/min) = | 20 | 2 |
| Unloading rate (mN/min) = | 20 | 2 |
| Creep (s) = | 30 | 30 |

| | |
|---|---|
| Computation Method = | ASTEM E-2546 & Oliver & Pharr |
| Indenter type = | I mm spherical 1 mm spherical |

*Note:
Because Control Sample was harder and smoother than the other samples,
a higher maximum force was used.

The Nano Mechanical Tester is based on the standards for instrumented indentation, ASTM E2546 and ISO 14577. It uses an already established method where an indenter tip with a known geometry is driven into a specific site of the material to be tested, by applying an increasing normal load. When reaching a pre-set maximum value, the normal load is reduced until complete relaxation occurs. The load is applied by a piezo actuator and the load is measured in a controlled loop with a high sensitivity load cell. During the experiment the position of the indenter relative to the sample surface is precisely monitored with high precision capacitive sensor. The resulting load/displacement curves provide data specific to the mechanical nature of the material under examination. Established models are used to calculate quantitative hardness and modulus values for such data. This method was carried out on a number of treat portions to determine the hardness of the treats of the present invention.

TABLE 8

| | Hardness | Hardness | Young's Modulus | Max. Depth |
|---|---|---|---|---|
| Sample | [Vickers] | [MPa] | [MPa] | [nm] |
| Control | 0.0305 ± 0.0033 | 0.323 ± 0.035 | 23.9 ± 3.3 | 6228 ± 487 |
| Test 5% Shot Size | 0.0109 ± 0.0005 | 0.115 ± 0.005 | 8.12 ± 0.61 | 2049 ± 73 |
| Reduction with | | | | |
| Nitrogen | | | | |
| Test 10% Shot Size | 0.0061 ± 0.0005 | 0.065 ± 0.005 | 3.84 ± 0.35 | 3538 ± 218 |
| Reduction with | | | | |
| Nitrogen | | | | |
| Test 20% Shot Size | 0.0074 ± 0.0005 | 0.078 ± 0.005 | 8.52 ± 1.50 | 2583 ± 96 |
| Reduction with | | | | |
| Nitrogen | | | | |
| Test 10% shot Size | 0.0099 ± 0.0021 | 0.104 ± 0.022 | 17.0 ± 3.8 | 1895 ± 354 |
| Reduction with | | | | |
| Carbon Dioxide | | | | |

### EXAMPLE 7

### Determination of Tensile Strength

Sample Preparation: Base material was injected molded into Tensile Bar shapes.

The testing method followed the standards outlined in ASTM D638, ISO 527.

The sample was placed in the grips of the testing machine, which pulled the sample apart at a rate of 1 mm s−1. The force required to pull the sample apart and the amount of sample stretch were measured. These values along with the sample cross-sectional area in the gauge region were used to calculate tensile properties. This process was repeated a number of times to determine the overall tensile strength of the treats of the present invention.

TABLE 9

| | | | Distance | Area to | | Area | Travel | |
|---|---|---|---|---|---|---|---|---|
| | | Peak | at peak | peak | | peak to | Peak to | Total |
| | | force | force | force | Distance to | break | Break | Area |
| | Batch | (kg) | (mm) | (mm2) | break (mm) | (mm²) | (mm) | (mm²0 |
| Average | Aerated | 5.561 | 39.452 | 163.768 | 42.681 | 17.547 | 3.230 | 181.342 |
| Values | Treat | | | | | | | |
| | Control | 11.013 | 45.712 | 407.955 | 56.764 | 118.852 | 11.052 | 526.857 |
| | Treat | | | | | | | |
| Standard | Aerated | 0.150 | 2.883 | 14.875 | 3.855 | 6.400 | 1.128 | 20.896 |
| Deviation | Treat | | | | | | | |
| | Control | 0.293 | 2.941 | 16.886 | 5.242 | 28.353 | 2.862 | 39.496 |
| | Treat | | | | | | | |

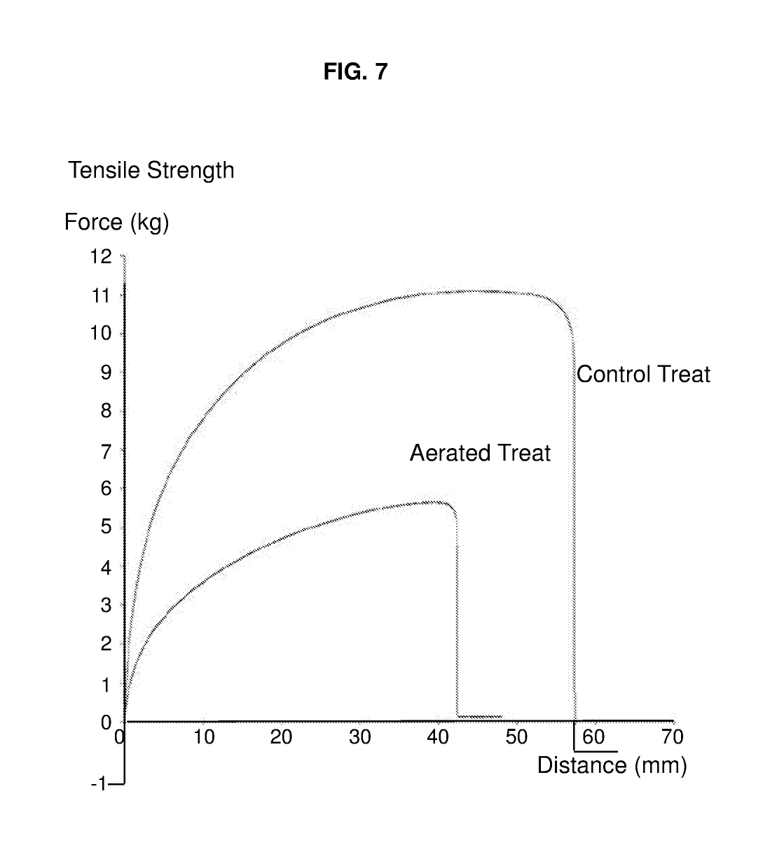

This data is illustrated in FIG. 7.

TABLE 10

| | Aerated | Control |
|---|---|---|
| | Treat | Treat |
| Youngs Modulus (MPa/%) | 0.165 | 0.41 |
| Ultimate Strength (MPa) | 1.364 | 2.702 |
| Ductility (%) | 53.352 | 70.955 |
| Modulus of Toughness | 55.597 | 161.573 |
| (MPa. %) | | |

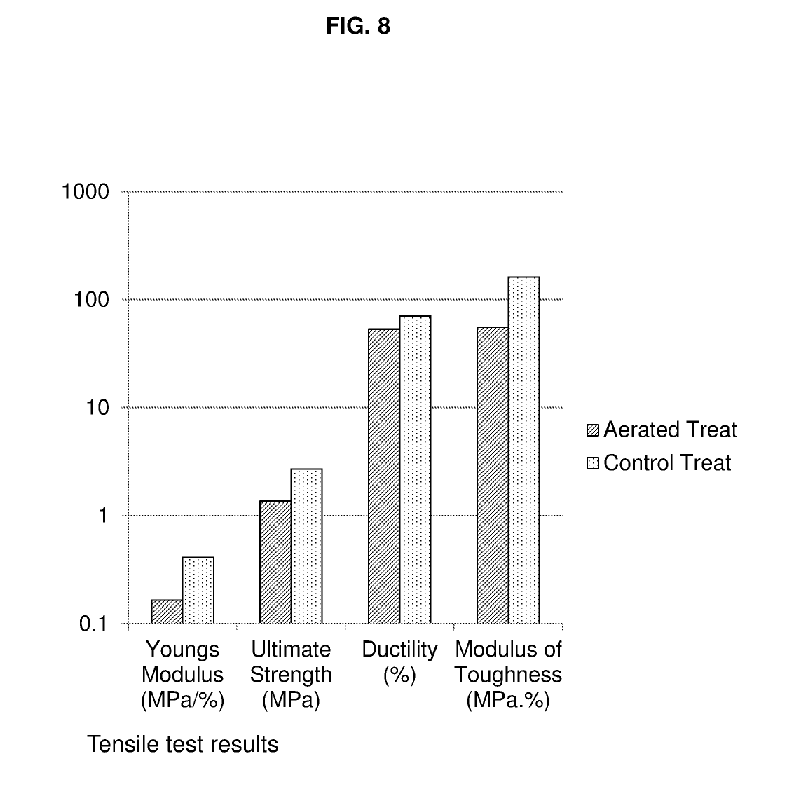

This data is illustrated in FIG. 8.

### EXAMPLE 8

### Determination of Cell Size and Distribution

The base material was injected molded into treat shape and analyzed.

Equipment: NSI Imagix microCT system

Spot Size: Small

Voltage: 50.0 kV

Amperage: 200 μA

# of Projections: 2160

Frame Averages: 1

Frames/sec: 1

Calibration Tool: Small (0.762 mm)

Beam Harden Correction: 0

Mode: Step

All samples were imaged at 18.2 micron voxel size. This means that only aeration above this 18.2 micron value will be observed and accurately segmented by the system. The samples were tested whole but only about a 2.5 to 3 cm section of the toothbrush handle for each sample was imaged.

X-ray tomography was used, which allows the viewing of internal structures that have different densities without cutting or altering the sample. The darker (more black) an area appears the lower the x-ray density of the material in that area. The whiter an area appears, the higher the x-ray density of the material in that area.

The aeration was determined by exporting the y slices from the x-ray tomography into the Amira software. The slices were reconstructed into a three dimensional structure. The air bubbles were segmented and their percentage of the whole volume was determined.

TABLE 11

| | Aerated Treat | Control Treat |
|---|---|---|
| Air Cell Count per cubic centimeter | 368,976 | 14,106 |
| Average Cell Volume (μm³) | 107,439.6 | 754,918.4 |
| Average Cell Diameter (μm) | 38.10 | 58.30 |
| Cell Diameter Standard Deviation | 12.73 | 28.58 |

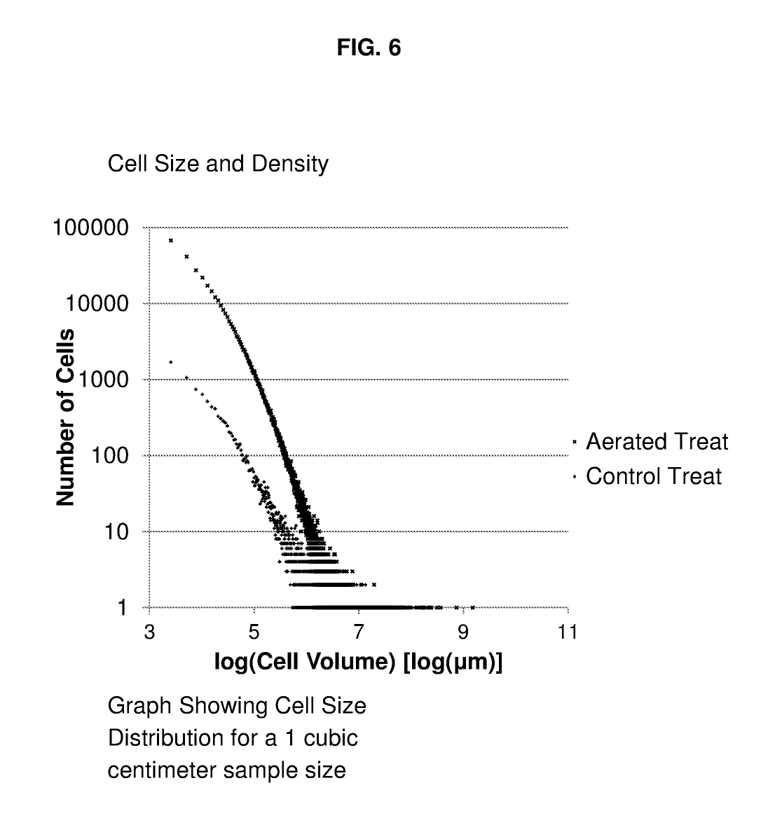

This data is illustrated in FIG. 6.

### EXAMPLE 9

This example provides three formulations of pet products: a natural pet chew, a lite natural pet chew, and a senior natural pet chew.

TABLE 12

| | | Label |
|---|---|---|
| | Limits | Declaration |
| Parameter | (Min/Max) | (%) |
| Pet Chew | | |
| Crude Protein | Minimum | 52.00 |
| Crude Fat | Minimum | 5.00 |
| Crude Fiber | Maximum | 1.50 |
| Moisture | Maximum | 15.00 |
| Senior Pet Chew | | |
| Crude Protein | Minimum | 19.00 |
| Crude Fat | Minimum | 4.00 |
| Crude Fiber | Maximum | 5.00 |
| Moisture | Maximum | 18.00 |
| Lite Pet Chew | | |
| Crude Protein | Minimum | 21.00 |
| Crude Fat | Minimum | 4.00 |
| Crude Fiber | Maximum | 5.00 |
| Moisture | Maximum | 18.00 |
| Kcal/Kg | Maximum | 2936 max |
| | | 3100 |

TABLE 13

| | | | | Senior Pet |
|---|---|---|---|---|
| GUARANTEED ANALYSIS | | Pet Chew | Lite Pet Chew | Chew |
| Crude Protein | min % | 52.0 | 21.0 | 19.0 |
| Crude Fat | min % | 5.0 | 4.0 | 4.0 |
| Crude Fiber | max % | 1.5 | 5.0 | 5.0 |
| Moisture | max % | 15.0 | 18.0 | 18.0 |
| Calcium | min % | 0.6 | 0.6 | 0.6 |
| Phosphorus | min % | 0.4 | 0.4 | 0.4 |
| Vitamin A | min IU/kg % | 6000 | 4500 | 4500 |
| Vitamin E | min IU/kg % | 650 | 650 | 650 |
| Glucosamine | max IU/kg % | | | 48 |
| Chondroitin | max IU/kg % | | | 450 |

| | |
|---|---|
| Calorie Content (Calculated) | |
| Calorie Content kcal/kg ME | 2936 |
| Calories/Serving | 83 |

All three pet chew embodiments will be formulated using turmeric and anthocyanins to produce an all-natural pet chew.

The following are the results of a digestibility and solubility test

Digestibility Study Results

TABLE 14
Digestibility Studies

| | Pet Chew | | Lite Pet Chew | |
|---|---|---|---|---|
| | Mean | SEM | Mean | SEM |
| Dry Matter (total) Digestibility | 92.6 | ±0.51 | 84.0 | ±0.48 |
| Protein Digestibility | 96.2 | ±0.19 | 89.0 | ±0.53 |
| Fat Digestibility | 88.0 | ±0.76 | 75.2 | ±0.86 |
| Caloric Digestibility | 93.9 | ±0.48 | 89.0 | ±0.45 |
| (using Atwater calculation) | | | | |
| Metabolizable Energy (M.E.) kcal/g | 3.65 | ±0.021 | 3.22 | ±0.016 |
| (using Atwater calculation) | | | | |
| Caloric Digestibility | 94.6 | ±0.35 | 84.0 | ±0.52 |
| (using Bomb Calorimetry) | | | | |
| Metabolizable Energy (M.E.) kcal/g | 3.68 | ±0.015 | 3.16 | ±0.020 |
| (using Bomb Calorimetry) | | | | |

The following is a graph of the total fecal consistency observations:

TABLE 15

| | | Dacron | Dried Sample | | | | Avg. | PH | PH | |
|---|---|---|---|---|---|---|---|---|---|---|
| Sample | Test | Fab Wt. | and Fabric | Residue | Blank | | % | Reading | Reading | Sample |
| Sets | Code | (g) | Final W. (g) | Wt. (g) | Residue | % IVD | IVD | Step 4 | Step 7 | Wt. (g) |
| Lite Pet | GLN A | 3.4 | 8.5 | 5.10 | 0.10 | 83.77% | 83% | 2.00 | 6.80 | 30.8 |
| Chew A | | | | | | | | | | |
| Lite Pet | GLN B | 3.5 | 8.7 | 5.20 | 0.10 | 83.44% | | 2.00 | 6.80 | 30.8 |
| Chew B | | | | | | | | | | |
| Lite Pet | GLN C | 3.5 | 9.0 | 5.50 | 0.10 | 82.47% | | 2.00 | 6.80 | 30.8 |
| Chew C | | | | | | | | | | |
| Senior Pet | 4SPTO A | 4.4 | 10.3 | 5.90 | 0.10 | 81.29% | 81% | 2.00 | 6.80 | 31.0 |
| Chew A | | | | | | | | | | |
| Senior Pet | 4SPTO B | 3.7 | 9.9 | 6.20 | 0.10 | 80.32% | | 2.00 | 6.80 | 31.0 |
| Chew B | | | | | | | | | | |
| Senior Pet | 4SPTO C | 4.8 | 11.0 | 6.20 | 0.10 | 80.32% | | 2.00 | 6.80 | 31.0 |
| Chew C | | | | | | | | | | |

TABLE 16
6 hr Gastric (HCI/Pepsin) with 18 hr Small Intestine (Pancreatin)

| | | | | | | | | | | | | |
|---|---|---|---|---|---|---|---|---|---|---|---|---|
| | | | Residue | | | | | | | | | |
| # | Spl. Wt. | Spl. Wt. | Wt. | % DMD | Length | Width | Height | Width | Height | Length | Width | Height |

| | | | | | | | | | | |
|---|---|---|---|---|---|---|---|---|---|---|
| 10 | 29.6090 | 26.4023 | 5.9900 | 77.31 | 105.0 | 22.0 | 15.0 | 26.5 | 17.0 | No Measurements |
| | | | | | | | | | | Possible |
| 11 | 29.6111 | 26.4042 | 5.5857 | 78.85 | 106.0 | 22.5 | 15.0 | 26.0 | 17.0 | No Measurements |
| | | | | | | | | | | Possible |
| 12 | 29.6352 | 26.4257 | 4.5052 | 82.95 | 106.0 | 22.0 | 15.0 | 26.0 | 17.0 | No Measurements |
| | | | | | | | | | | Possible |

The pet chew formulations of this Example show improved digestibility and solubility when compared to pet chews currently available on the market. Further, they provide a natural green color.

The foregoing description and drawings merely explain and illustrate the invention and the invention is not limited thereto, as those skilled in the art who have the disclosure before them will be able to make modifications and variations therein without departing from the scope of the invention.

What is claimed is:

1. A pet product composition comprising one or more natural colorants, the composition being saturated with a supercritical fluid.

2. The pet product composition of claim 1, comprising a protein component comprising an amount of dairy protein of less than 10% by weight.

3. The pet product composition of claim 1, comprising greater than 2×10⁴ cells per cubic centimeter (cc) of the aerated pet chew composition, wherein the cells are created by the release of an amount of supercritical fluid sufficient to occupy 5-55% of the overall volume of the composition when the supercritical fluid is transformed to gas.

4. The pet product composition of claim 1, wherein the one or more natural colorants comprise a combination of anthocyanins and turmeric.

5. The pet product composition of claim 4, wherein at least one of the anthocyanins is derived from at least one member of the group consisting of Vaccinium species, such as blueberry, cranberry, and bilberry; Rubus berries, including black raspberry, red raspberry, and blackberry; blackcurrant; cherry; eggplant peel; black rice; Concord grape; muscadine grape; red cabbage; violet petals; black soybean; skins of black chokeberry; Amazonian palm berry; blood orange; marion blackberry; cherry; redcurrant; purple corn; and acai.

6. The pet product composition of claim 2, wherein the protein component further comprises 30-50% by weight fibrous protein and 15-25% gelling protein.

7. The pet product composition of claim 2, further comprising up to 40% by weight of plasticizer.

8. The pet product composition of claim 7, wherein the plasticizer comprises glycerin

9. The pet product composition of claim 6, further comprising from 0.05-27.55% by weight of an additional ingredient selected from flavor enhancers, fat, vitamins, minerals, preservatives, and any combination thereof.

10. The pet product composition of claim 3, wherein the cells have an average diameter of 0.05 to 200 μm.

11. The pet product composition of claim 4, wherein the combined amount of the anthocyanins and turmeric comprises from about 0.005% to 5.0% by weight of the chew.

12. The pet product composition of claim 11, wherein the amount of supercritical fluid within, or used to produce, the composition is from 0.01 to 0.05 wt %, based upon the total weight of the composition.

13. The pet product composition of claim 11, wherein the combination of anthocyanins and turmeric provides the pet product composition with a green color having a Pantone reference range of from about P 163-14 U to about P 165-16 U.

14. The pet product composition of claim 12, wherein the combination of anthocyanins and turmeric provides the pet product composition with a green color having a wavelength of from 490 nm to 560 nm.

15. A method of making a pet product comprising:
Preparing a pet product composition comprising one or more natural colorants and saturated with a super critical fluid;
Adjusting the temperature and pressure conditions surrounding the pet product composition so that the supercritical fluid expands and diffuses at least partially through the pet product composition.

16. The method of claim 15, further comprising forming the pet product composition into a pet product.

17. The method of claim 15, wherein the pet product composition is prepared by introducing a supercritical fluid into a pet product composition within an extruder, a high pressure chamber, a static mixer, or a combination of these.
